(19) United States
(12) Patent Application Publication
(10) Pub. No.: US 2019/0191706 A1
(43) Pub. Date: Jun. 27, 2019

(54) BACTERIOPHAGES TO CONTROL SHIGATOXIGENIC ESCHERICHIA COLI

(71) Applicant: The Board of Regents for Oklahoma State University, Stillwater, OK (US)

(72) Inventors: DIVYA JARONI, Stillwater, OK (US); PUSHPINDER KAUR LITT, Stillwater, OK (US)

(73) Assignee: The Board of Regents for Oklahoma State University, Stillwater, OK (US)

(21) Appl. No.: 16/307,501

(22) PCT Filed: Jun. 6, 2017
(86) PCT No.: PCT/US17/36138

§ 371 Date: Dec. 6, 2018

Related U.S. Application Data
(60) Provisional application No. 62/346,256, filed on Jun. 6, 2016.

(51) Int. Cl. A01N 63/00; A23L 3/3463; A23B 4/22; A23B 7/155

(52) U.S. Cl. CPC A01N 63/00; A23L 3/34635; A23V 2002/00; A23B 7/155; A23B 4/22

(57) ABSTRACT

Host-specific bacteriophages that kill or prevent growth of shigatoxigenic Escherichia coli (STEC) are provided. The bacteriophages are specific for STEC, exhibit high lytic activity, pH, and thermal stability, and are used as bio-control agents in the meat and produce industry. Notably, the bacteriophages prevent or reduce STEC biofilm formation.

### CROSS REFERENCE TO RELATED APPLICATIONS

This application claims the benefit of U.S. Provisional Patent Application Ser. No. 62/346,256 filed on Jun. 6, 2016, and incorporates said provisional application by reference into this document as if fully set out at this point.

### TECHNICAL FIELD

This disclosure relates generally to bacteriophages that can be used to control shigatoxigenic Escherichia coli (STEC) in the food industry.

### BACKGROUND

Shiga-toxigenic Escherichia coli (STEC) are critically important foodborne pathogens responsible for multiple foodborne outbreaks associated with fresh-produce and meat products. One of the most severe infections caused by STEC is hemolytic uremic syndrome (HUS) which can lead to kidney failure, predominantly among children, elderly and immunocompromised individuals. Human illnesses due to consumption of foods contaminated with STEC can also lead to direct and indirect costs of 400-700 million dollars per year in the U.S. Some of the high risk food commodities include spinach, romaine lettuce, sprouts, salad-blends, tomatoes, apple-juice, dairy, and meat products.

Introduction of STEC to food can occur in various ways, such as, direct contact with untreated manure or contaminated soil in the field, poor quality of irrigation or processing water, direct contact with animals, birds, insects or infected personnel. Additionally, food can be cross-contaminated at the processing facility and during transportation by a variety of methods. These STEC can then persist on foods, food-contact surfaces and non-food contact surfaces under optimum conditions.

More recent findings have revealed that bacteria can also form biofilms when infecting a surface or food item. Biofilms are secretions made by an aggregate of bacteria to form a protective layer around them. These are very difficult to penetrate and pose a significant challenge to the food industry as they make conventional control methods, such as chlorine, insufficient.

Currently, the food industry relies heavily on chemical interventions to alleviate the problem of STECs. There is a need in the art for non-chemical methods to effectively control STEC.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

Bacteriophages are environmentally-friendly viruses that are extremely host-specific, are commonly found in nature, and serve as an attractive alternative to kill and control STEC in the food industry. The present disclosure describes the isolation, identification, and molecular and physio-morphological characterization of STEC-infecting bacteriophages, isolated from environmental samples. The bacteriophages referred to herein specifically target and kill STEC (such as E. coli O157:H7 and nonO157 STEC) prevailing in foods, food-contact surfaces, non-food surfaces, food-animals and/or in biofilms and therefore are an attractive alternative for controlling STEC and their biofilms in the food industry. The bacteriophages exhibit high lytic activity, low and high pH tolerance, and thermal and cold storage stability and thus are useful as bio-control agents in the food industry. The bacteriophage compositions provide a safe alternative to chemical-based pathogen control strategies currently used by the food industry.

One aspect of the invention provides a method of killing or inhibiting growth of STEC, which comprises of contacting the STEC with a composition containing at least one of the bacteriophages described herein. In some embodiments, the composition comprises a plurality (i.e. a “cocktail”) of bacteriophages. In some embodiments, the STEC is a serotype selected from the group consisting of O157:H7, O26, O111, O103, O121, O145, and O45. In further embodiments, the contacting step comprises applying, spraying or drenching a surface with the composition. The surface may be or is present in or on: food processing equipment, flooring, food-contact surfaces, or non-food-contact surfaces. In other embodiments, the surface is or is present in or on a carcass or fresh produce. In some embodiments, the composition is in the form of a spray, a wipe impregnated with the composition, a bulk liquid, a powder, or granules.

Another aspect of the invention provides a method of preventing or reducing formation of a STEC biofilm on a surface, comprising applying to the surface a composition comprising at least one of bacteriophages described herein.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIGS. 1A-1Z and 1AA-1AZ provide TEM images of exemplary phages of the invention: (1A) P1, (1B) P2, (1C) P3, (1D) P4, (1E) P5, (1F) P6, (1G) P7, (1H) P8, (1I) P9, (1J) P10, (1K) P11, (1L) P12, (1M) P13, (1N) P14, (1O) P15, (1P) P16, 1(Q) P17, (1R) P18, (1S) P19, (1T) P20, (1U) P21, (1V) P22, (1W) J1, (1X) J2, (1Y) J3, (1Z) J4, (1AA) J5, (1AB) J6, (1AC) J7, (1AD) J8, (1AE) J9, (1AF) J10, (1AG) J11, (1AH) J12, (1AI) J13, (1AJ) J14, (1AK) J15, (1AL) J116, (1AM) J17, (1AN) J18, (1AO) J19, (1AP) J20, (1AQ) J21, (1AR) J22, 1(AS) J23, (1AT) J24, (1AU) J25, (1AV) J26, (1AW) J27, (1AX) J28, (1AY) J29, and (1AZ) J30.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments so described.

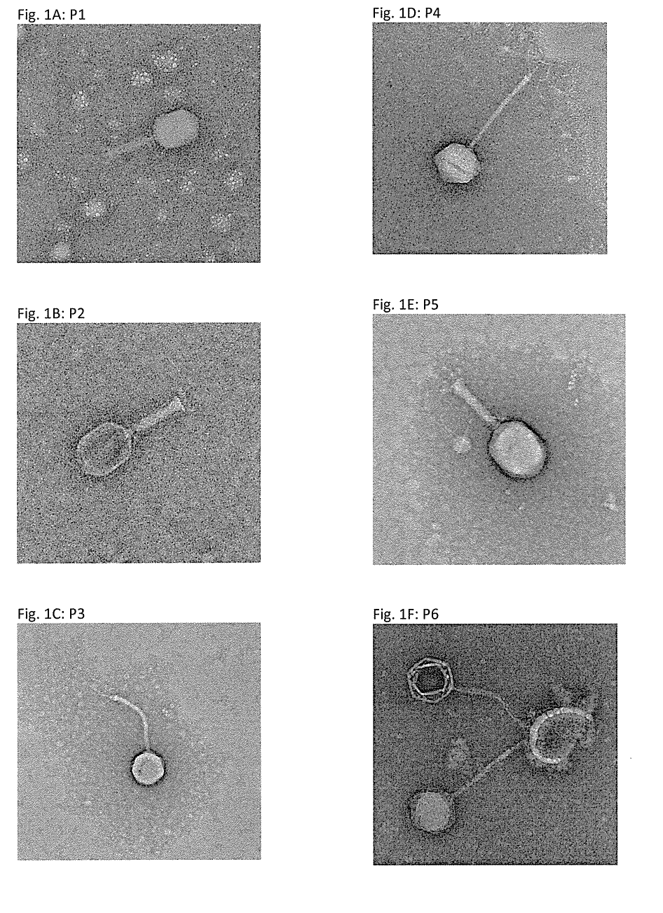

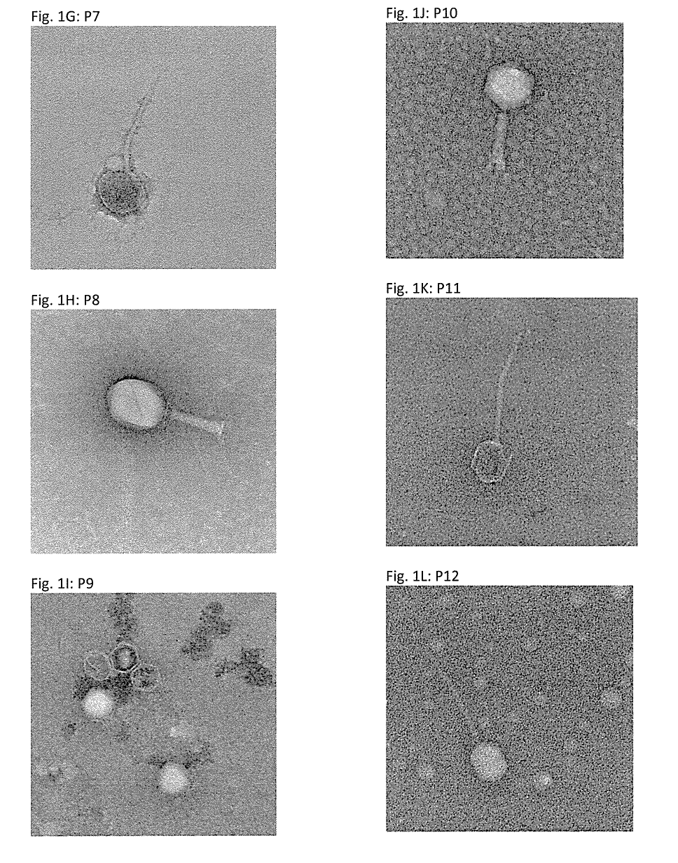

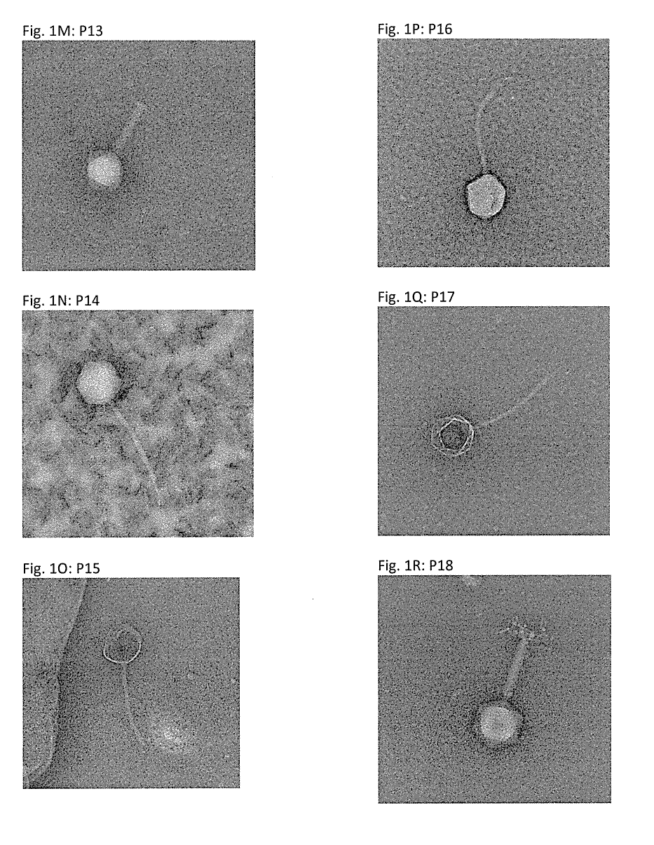

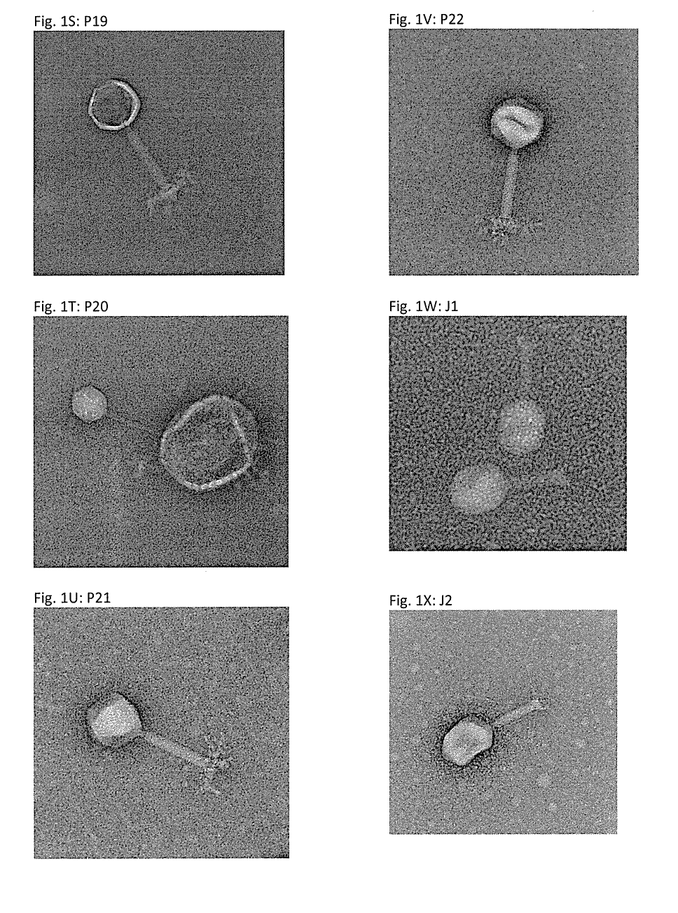

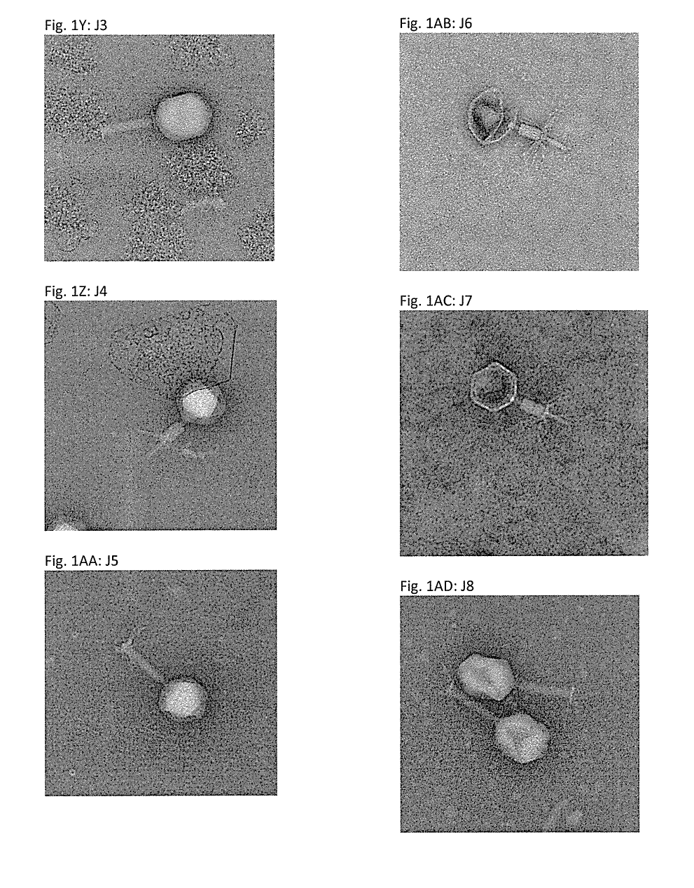

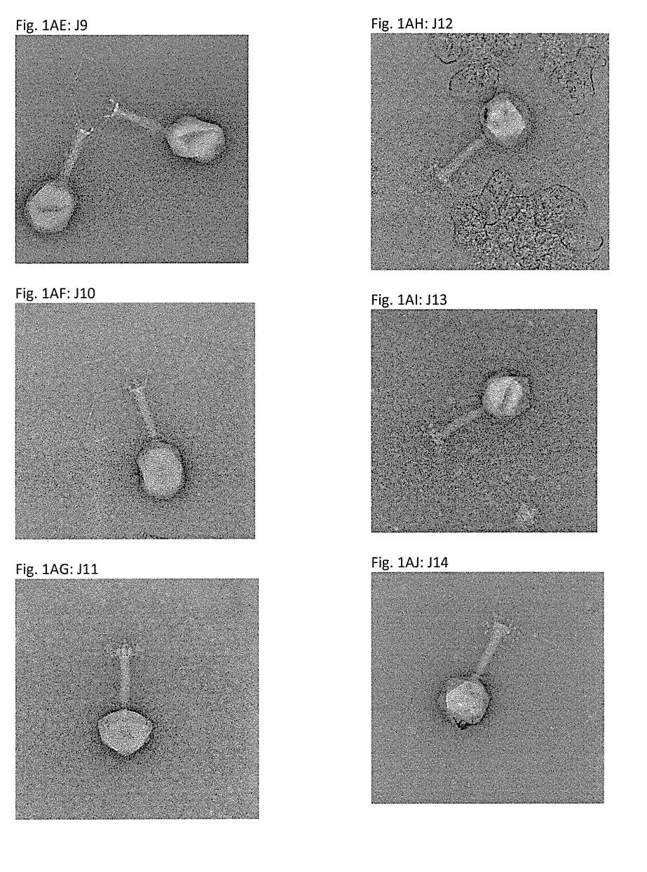

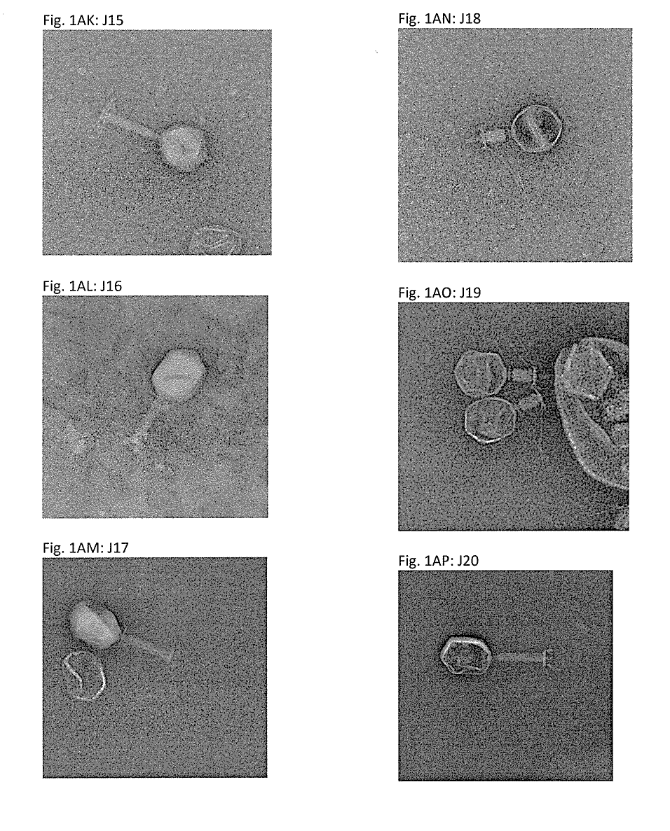

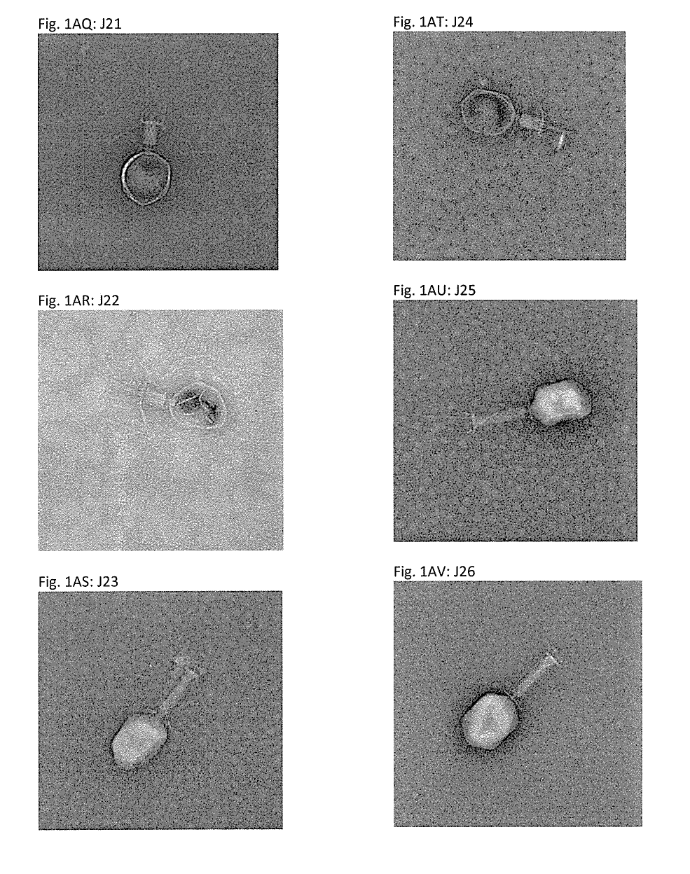

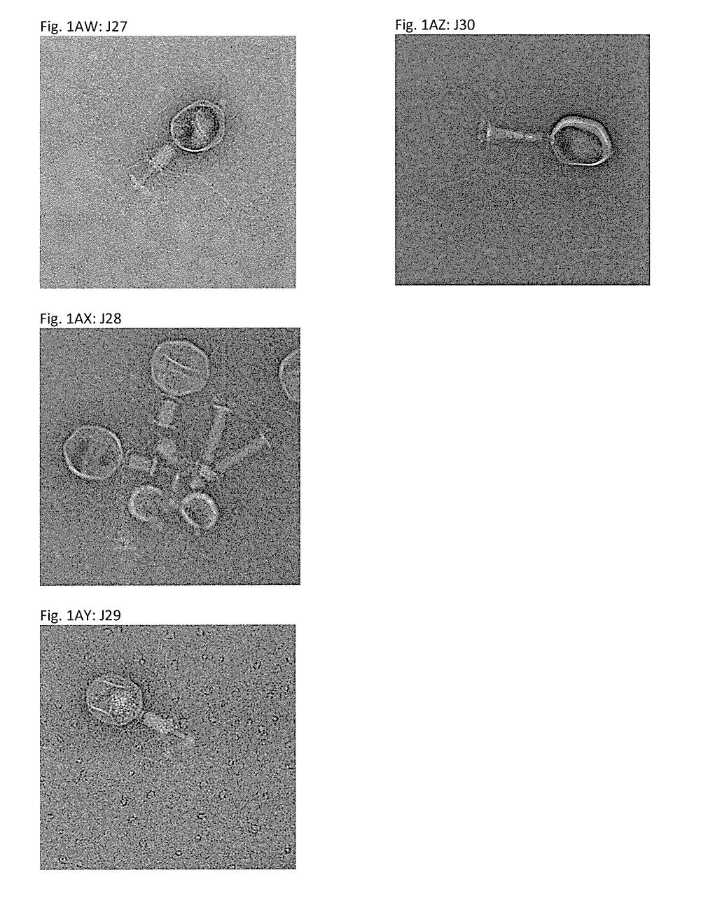

Described herein are 52 bacteriophages of the Myoviridae, Siphoviridae, or Tectiviridae families isolated from water and bovine fecal samples from beef cattle operations in Oklahoma. TEM images of each of the bacteriophages is shown in FIGS. 1A-1Z and 1AA-1AZ. The bacteriophages have inhibitory activity against at least 7 serotypes of STEC: O157:H7, O26, O45, O103, O111, O121, and O145. The bacteriophages also exhibit high lytic activity, pH, and thermal stability.

As used herein with respect to bacteriophage, “isolated” refers to a bacteriophage that has been separated from the environment in which it is naturally found (e.g., that does not contain a significant amount of the bacterial host).

As provided in the Example, the isolated bacteriophages are referred to as provided in Table 1 and have the corresponding ATCC deposit numbers.

TABLE 1
Assigned names of 52 isolated bacteriophages

| Bacteriophage | | |
|---|---|---|
| No. | Name and (Sample ID) | ATCC Deposit No. |
| 1. | P1 (C-1) | |
| 2. | P2 (C-2) | |
| 3. | P3 (C-3) | |
| 4. | P4 (C-4) | |
| 5. | P5 (C-5) | |
| 6. | P6 (D-2) | |
| 7. | P7 (G-5) | |
| 8. | P8 (A-7) | |
| 9. | P9 (A-7) | |
| 10. | P10 (A-1) | |
| 11. | P11 (A-5) | |
| 12. | P12 (D-2) | |
| 13. | P13 (D-5) | |
| 14. | P14 (I-1) | |
| 15. | P15 (I-2) | |
| 16. | P16 (I-4) | |
| 17. | P17 (I-5) | |
| 18. | P18 (I-1) | |
| 19. | P19 (I-2) | |
| 20. | P20 (I-3) | |
| 21. | P21 (I-4) | |
| 22. | P22 (I-5) | |
| 23. | J-1 (D-1) | |
| 24. | J-2 (D-2) | |
| 25. | J-3 (D-3) | |
| 26. | J-4 (B-1) | |
| 27. | J-5 (B-3) | |
| 28. | J-6 (B-4) | |
| 29. | J-7 (B-5) | |
| 30. | J-8 (I-2) | |
| 31. | J-9 (I-3) | |
| 32. | J-10 (I-4) | |
| 33. | J-11 (D-1) | |
| 34. | J-12 (D-2) | |
| 35. | J-13 (D-3) | |
| 36. | J-14 (D-4) | |
| 37. | J-15 (D-5) | |
| 38. | J-16 (B-1) | |
| 39. | J-17 (B-2) | |
| 40. | J-18 (B-3) | |
| 41. | J-19 (B-4) | |
| 42. | J-20 (B-5) | |
| 43. | J-21 (D-1) | |
| 44. | J-22 (D-2) | |
| 45. | J-23 (D-3) | |
| 46. | J-24 (D-4) | |
| 47. | J-25 (D-5) | |
| 48. | J-26 (I-1) | |
| 49. | J-27 (I-2) | |
| 50. | J-28 (I-3) | |
| 51. | J-29 (I-4) | |
| 52. | J-30 (I-5) | |

The inventors have deposited biological samples containing the bacteriophages as described herein at the American Type Culture Collection (ATCC, 10801 University Boulevard, Manassas, Va. 20110), in accordance with the terms of Budapest Treaty on ______. The deposited samples have the ATCC deposit numbers as listed in Table 1. Under the terms of the Budapest Treaty, all restrictions on accessibility will be irrevocably withdrawn upon the granting of the patent and the deposit will be replaced if viable samples cannot be dispensed by the depository.

Embodiments of the invention also encompass progeny of the bacteriophage listed in Table 1, i.e. replicates of the bacteriophage, including descendants of the bacteriophage created by serial passage or other methods known in the art.

Bacteriophages as described herein having one or more mutations (such as point mutations, insertions, deletions and duplications) while maintaining substantial functional activity are also contemplated. In some embodiments, the bacteriophage has a genome sequence at least 80%, 85%, 90%, 95%, 96%, 97%, 98%, or 99% identical to a genome sequence of a bacteriophage provided in Table 1.

In some embodiments, a plurality of isolated bacteriophages is combined in a composition for use in a method as described herein. A plurality refers to at least two bacteriophages, e.g. 2, 3, 4, 5, 6, 7, 8, 9, 10, etc. up to all 52 bacteriophages in any combination. The cocktails may include additional components as described herein. For example, a bacteriophage composition can include media, buffers, one or more nutrients, one or more minerals, one or more co-factors, or any other component that is necessary to maintain viability of the bacteriophage. Additionally, components that are not related to the viability of the bacteriophage may be desirable in a bacteriophage composition such as, without limitation, a dye or color marker. Exemplary bacteriophage cocktails are provided in Table 2.

TABLE 2
Exemplary bacteriophage cocktails

| Cocktail No. | Bacteriophages |
|---|---|
| 1 | P1, P2, P4, P6 |
| 2 | P1, P2, P5, P7 |
| 3 | P3, P5, P7 |
| 4 | P2, P3, P4, P7 |
| 5 | P10, P11, P12, P13 |
| 6 | P9, J12, J13, J15 |
| 7 | P19, P20, P21 |
| 8 | P14, P15, P16, P17 |
| 9 | P8, J1, J4, J7 |
| 10 | P8, J3, J6, J9 |
| 11 | J21, J24, J26, J27 |
| 12 | J25, J28, J29, J30 |
| 13 | J18, J21, J27, J29 |
| 14 | P2, P6, P7, P11, P12, P13, P9, J12, |
| | J15, P19, P20, P21, P14, P15, P17, |
| | P8, J3, J7, J18, J21, J29 |
| 15 | P3, P4, P5, P6, P7 |
| 16 | P4, P6 |
| 17 | P3, P5 |
| 18 | P6, P7 |
| 19 | P3, P4, P7 |
| 20 | P1, P2 |
| 21 | P10, P13, P11 |
| 22 | P10, P11, P12 |
| 23 | P11, P12, P13 |
| 24 | P9, J12, J13 |
| 25 | P9, J12, J15 |
| 26 | P9, J13, J15 |
| 27 | J12, J13, J15 |
| 28 | P19, P20 |
| 29 | P20, P21 |
| 30 | P19, P21 |
| 31 | P14, P15, P16 |
| 32 | P14, P15, P17 |
| 33 | P15, P16, P17 |
| 34 | P8, J1, J4 |
| 35 | P8, J1, J7 |
| 36 | J1, J4, J7 |
| 37 | P8, J3, J6 |
| 38 | P8, J3, J9 |
| 39 | J3, J6, J9 |
| 40 | J1, J3, J4 |
| 41 | J1, J6, J7 |
| 42 | J1, J6, J9 |
| 43 | J1, J4, J9 |
| 44 | J1, J3, J7 |

The isolated bacteriophages, either alone or in various combinations (i.e. “cocktails”) can be used to control biofilm forming STECs and thus have tremendous utility in the food industry. Compositions comprising such bacteriophages can be used to kill specific STECs or to disperse biofilms in various food industry applications.

Among the many applications that are suitable for the isolated phages or combinations thereof are the following:
a. Surface sanitation or decontamination, including food processing facility sanitation:
   i. Inanimate hard surfaces.
      1. Examples include: Food processing equipment, flooring, food-contact surfaces, non-food-contact surfaces.
   ii. Food surfaces.
      1. Examples: Meat and poultry carcasses, fresh produce
b. Phage treatment of foods
   i. Meat and meat products (beef, pork, goat meat, sheep meat)
   ii. Milk and dairy products
   iii. Eggs and poultry products
   iv. Fresh produce, fresh-cut produce, processed fresh produce or ready-to-eat (RTE) and minimally processed fresh produce
c. Treatment in live animals by oral administration (through feed, water, dietary supplement) or topical administration
d. Treatment of fresh produce on-farm
   i. Irrigation water
e. Treatment of fresh produce at processing
   i. Wash water
   ii. Spray
   iii. Dip-treatments
f. Use in combination with other sanitizers or as pre-treatment of other sanitizers for removal of biofilms
g. Use as a probiotic
   i. In animals, potentially including humans.

As described above, the compositions contemplated herein have both agricultural and industrial applications. The bacteriophage compositions may be used to kill or inhibit the growth of STEC by contacting the STEC with a composition comprising at least one or a plurality of the bacteriophages described herein. In some embodiments, the composition is used to prevent or reduce the formation of a STEC biofilm on a surface by applying to the surface a composition comprising at least one of or a plurality of the bacteriophages described herein.

In some embodiments, the compounds of the invention may be incorporated into a wipe (e.g., impregnated or soaked into a paper or cloth or sponge or other suitable substrate) to control or eliminate STEC, for example, in food service areas (e.g., by wiping surfaces contacted by the food or surfaces of the food itself). Many compositions, having multiple compounds, show synergistic bactericidal and/or fungicidal activity.

An additional application involves the use of a bacteriophage composition to combat growth of one or more bacteria in food processing applications, or harvesting applications, or in the field during growth phase of plants that produce the food products. For example, the composition may also be applied to soil as fumigants or as a drench, and to foliage as a spray, mist, or drench.

Stored commodities such as fruit, vegetables, dairy, and meat products may be treated with a bacteriophage composition.

The bacteriophage composition may be applied as an aqueous spray or may be made into a solution with an ionic, non-ionic or cationic emulsifier, such as any surfactant having a hydrophile-lipophile balance (HLB, see, for example, W. C. Griffin, J. Soc. Cosmetic Chemicals, 1: 311, 1949) of 1-20, and then applied as a spray. The composition may be used for disinfection by fumigation or drench of packaging or enclosed containers that will contain foods, such as harvest bins, storage chambers and shipping containers. Fumigation may, for example, be accomplished by spraying an aqueous solution or powder, by vaporization of extracts, or by incorporating the extracts into a time-release device such as by encapsulation in a polymer matrix, polyvinylchloride strip, or rubber pellets.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

The invention is further described by the following non-limiting examples which further illustrate the invention, and are not intended, nor should they be interpreted to, limit the scope of the invention.

### EXAMPLE

### Introduction

This Example describes the isolation, identification, and molecular and physio-morphological characterization of STEC-infecting bacteriophages isolated from beef cattle operations in Oklahoma.

### Materials and Methods

### Bacteriophage Isolation

Water (n=172) and bovine fecal samples (n=60) were collected from feedlot and cow-calf cattle operations in Oklahoma. Samples were tested for the presence of bacteriophages specific to STEC serotype O157:H7, O26, O45, O103, O111, O121, and O145. Cultures for each test pathogen strain were prepared by inoculating cryo-preserved cells in tryptic soy broth (TSB) and incubated overnight (18-20 hour) at 37° C. Two transfers of overnight culture were performed before preparing a working culture. Collected sample (10 ml) was enriched in 25 ml of double strength NZ-amine casamino acid yeast extract sodium chloride magnesium sulfate (NZCYM) with 10 ml overnight grown bacterial culture and incubated for 18 hrs at 37′C. A similar procedure was followed for every STEC serotype tested. After incubation, a 2 ml suspension was collected and centrifuged at 12,000 rpm for 10 mins. Supernatant was then filtered using a 0.45μ syringe filter. Filtrate was plated on NZCYM plate via a double layer agar method. Isolated phages were purified and eluted in SM buffer (10 mM Tris-HCl, pH 7.5; 100 mM NaCl; 10 mM MgSO4) and stored at 4′C.

### Characterization

### Inhibition Assay

The host-range of all the phages was tested using spot-on-lawn assay against several STEC strains: E. coli O157:H7 (ATCC 43895, 43888, lab wild-type strains) and Non-O157 E. coli serotypes (O26, O45, O103, O111, O121, O145).

### Thermal Stability

Phage particles at about 10₈ PFU/ml were suspended in 1 ml SM buffer and incubated at 40, 60, 70 & 90° C. Sample (100 μl) was collected every 10 min for up to 60 mins. The surviving phages were serially diluted and then plated with the double layer agar method. Each experiment was carried out in triplicate and the results were reported as the mean of phage counts (PFU/ml).

### pH Stability

Bacteriophages at approximately 10⁸ PFU/ml were suspended in 1 ml SM buffer, previously adjusted with 1M NaOH or 1M HCl, to yield a pH range from 1.0 to 11.0. Sample (100 μl) was collected after 1, 2, 4, 6, 12, and 24 hrs of incubation at 37° C. and each sample was serially diluted and tested by double layer agar assay to check the viability of phage. Each experiment was carried out in triplicate and the results were reported as the mean of phage counts (PFU/ml).

### Storage Stability

Bacteriophages at approximately 10⁸ PFU/ml were suspended in 1 ml SM buffer and stored at 4, −20 and −80° C. for 3 months. Sample was collected after 1, 30, 60, and 90 days for enumeration of surviving phage population. Sample was serially diluted and then plated using double layer agar method.

### Bacteriophage Morphology

Phage samples were negatively stained with 2% phosphortungstic acid on carbon-coated grids and examined under transmission electron microscopy (JEM-2100TEM, JEOL). Electron micrographs were taken at a magnification of 50,000× (Oklahoma Technology & Research Park Venture, Oklahoma State University, Stillwater, Okla., USA).

### Phage Adsorption

The overnight grown culture of host strain was centrifuged and suspended in SM buffer to the concentration of 10⁹ CFU/ml. One ml of bacteria were infected with 10⁸ PFU/ml of phage suspension to give a MOI of 0.1 and incubated at 37° C. At 20 min intervals, aliquots of 100 μl were added to 900 ml of SM buffer and centrifuged 2 min at 12,000 g. The supernatant containing un-adsorbed phages was filtered through a 0.2μ filter, serially diluted, and titrated by double layer agar method.

### One-Step Growth Kinetics

For the one-step growth experiment, 1 ml of the overnight grown culture of host strain (10⁹ CFU/ml) was centrifuged and suspended in 900 μl of SM buffer. The suspension was infected with 100 μl of 10⁸ PFU/ml phage stock (MOI 0.1). The phage was allowed to adsorb on the bacteria for 10 min at 37° C. After incubation, the suspension was centrifuged at 13,000×g for 1 min. The supernatant was removed and subjected to plaque assay to determine the titer of the un-adsorbed phage. The pellet containing (partially) infected cells was immediately re-suspended in 10 ml of pre-warmed TSB.

After taking the first sample, the tube was returned to the incubator (37° C.). A sample (100 μl) was collected every 5 min (up to 60 min). Each sample was immediately diluted and subjected to plaque assay. All assays were carried out in triplicate. The experiment was repeated three times. Latent period was defined as the time interval between the end of the adsorption and the beginning of the first burst, as indicated by the initial rise in phage titer.

### Phage Inhibitory Concentrations Against STEC

Bacteriophages were serially diluted in PBS buffer to get 10⁻¹⁰ to 10² PFU/ml population of phages. On a pre-prepared lawn of E. coli O157:H7 (ATCC-43895), 10 μl from each phage dilution was spotted and plate incubated at 37° C. for 18-22 hr. A similar procedure was followed for bacteriophages specific to STEC O26, O45, O103, O111, O121 and O145 strains. After incubation, inhibition of host bacteria by its respective phage was quantified on the basis of clarity of inhibition (lysis) zones as: clear (+++), turbid (++), individual small plaques (+) or no reaction (−). The phages were then differentiated into three categories: very strong (+++), strong (++), weak (+) and non (−) inhibitors.

### Molecular Characterization

Bacteriophage DNA was isolated using a phenol-chloroform method and digested with HindIII restriction enzyme. The digested fragment was cloned in pBluescript vector and transformed into E. coli XO1 Blue. Sequenced DNA fragment was analyzed using national center of biotechnology (ncbi.nlm.nih.gov/) database. The basic local alignment search tool (BLAST) was used to compare the sequenced DNA with the database sequences and the statistical significance of the matches was determined.

### In-Vitro STEC Biofilm Inhibition Assay: Individual or Cocktail of Phages

For the biofilm inhibition assay, an overnight culture of all STEC strains (O157, O26, O45, O103, O111, O121, O145), was prepared at 370° C. in LB media; diluted (1:100) in 10 ml of M9 medium with glucose (0.4%, wt/vol) and minerals (1.16 m MMgSO₄, 2 μM FeCl₃, 8 μg MCaCl₂, and 16 μM MnCl₂) and incubated for 24 hr at 370° C. These cultures (either individual or in cocktail) were diluted (1:100) in M9 medium, supplemented with glucose and minerals, and inoculated in triplicates into the microtiter plates. Wells filled with sterile media were used as the experimental control. After 24-hr incubation at 37° C., unattached cells were removed by washing three times with PBS. Plates were dried at 37° C. for 15 min, and 150 μl of bacteriophage treatment (either individual or cocktail) was added, specific to the target bacteria. In the positive control wells 150 μl of PBS was added and the plates were incubated at 370° C. for 0, 3, or 6 hr. After incubation, phage solution was removed and the wells were washed three times with PBS to remove any remaining phage particles. Plates were dried at 37° C. for 15 min, and biofilm disruption measured with crystal violet (CV) staining (0.1% [wt/vol]) for 2 min. The CV solution was removed, the wells washed three times with PBS and then dried at 37° C. for 15 min. The stain was released with 150 μl of 80% (vol/vol) ethanol and 20% (vol/vol) acetone. Three wells filled with above mentioned ethanol acetone solution were used as the blank value. Biofilm disruption was quantified by measuring the absorbance at 595 nm with a microplate reader.

Bacteriophage Cocktails (CT) used in the experiment:

O157:H7
CT-1 - P1, P2, P4, P6
CT-2 - P1, P2, P5, P7
CT-3 - P3, P5, P7
CT-4 - P2, P3, P4, P7
O26
CT-5 - P10, P11, P12, P13
O45
CT-6 - P9, J12, J13, J15
O103
CT-7 - P19, P20, P21
O111
CT-8 - P14, P15, P16, P17
O121
CT-9 - P8, J1, J4, J7
CT-10 - P8, J3, J6, J9
O145
CT-11 - J21, J24, J26, J27
CT-12 - J25, J28, J29, J30

### Inhibition of STEC on Stainless Steel and HDPE Surfaces Using Phage Cocktails

Stainless steel (SS) and high density polyethylene (HDPE) are the most commonly used surface materials in food processing facilities. To simulate food processing settings, coupons of these materials were used to observe the inhibition of biofilm-forming STEC (O157:H7, O26, O45, O103, O111, O121 and O145) on food contact surfaces. A cocktail of selected bacteriophages and, suspended in phosphate buffered saline (PBS), was used for treating the SS or HDPE surfaces. The coupons (SS or HDPE, 2×5 cm²) were inoculated with a cocktail (1:1:1:1 ratio) of four strains of E. coli O157:H7 at a population of 10⁶ CFU/cm² and dried (5 hr) in a biosafety hood to let bacteria adhere to the surface and form biofilms. A similar procedure was followed for inoculum preparation of all the other E. coli strains. After inoculation, coupons were rinsed in sterile distilled to remove unattached bacterial cells from the surface. One coupon of each surface material (SS or HDPE) was sampled to determine the initial pathogen populations (inoculated untreated-control). The remaining inoculated coupons were then suspended in selected bacteriophage (10⁹ PFU/cm²) treatment solution for 16 h. Coupons were also suspended in PBS, as the control. After the 16 h suspension, coupons were sonicated for 5 minutes at 40 KHz to dislodge bacterial cells from coupon surface. Immediately following, 3 g of glass beads were added to the tube and agitated using vortex for 1 min, to remove any remaining attached cells from the coupon. Surviving pathogen population in the tube was determined by spread plating on tryptic soy agar. Bacterial colonies (CFU/cm²) were counted after 18-24 h of incubation at 37′C. All the experiments were repeated 3 times. Surviving STEC populations, recovered after treatments, were converted to log₁₀ CFU/cm² and mean values of the three replicates obtained. Data were analyzed using general linear model (SAS v.9.3 software; SAS Inst., Cary, N.C., USA) to determine analysis of variance (ANOVA) for main effects of treatments. Significant differences between the treatment means were separated by the least significant difference (LSD) at P<0.05.

### Inhibition of STEC on Leafy Greens Using Individual or Cocktail of Phages

Leafy greens tested were spinach and romaine lettuce. Prepared leafy green samples were transferred to petri-plates containing moistened filter paper and spot-inoculated with 5 log₁₀ CFU/ml of either, individual strains of E. coli O26, O45, O103, O111, O121 and O145 or cocktail of E. coli O157:H7. Leaves were spray-treated with phages (8 log₁₀ PFU/ml) or PBS-control, using airbrush filled with treatment solution (O157:H7-specific phages P1, P2, P5, P7 or specific phage solution). Treated leaves were stored for 72 h at 4′C. Surviving bacteria were enumerated at 0 h, 24 h, and 72 h and data analyzed using one way ANOVA (P<0.05).

### Results

Results were reported as plaque forming units (PFU)/ml and converted into log₁₀ PFU/ml.

TABLE 3
Bacteriophage Isolation, Inhibition Assay and Morphology Classification

| | Inhibiting | | | | | | | | Morphology |
|---|---|---|---|---|---|---|---|---|---|
| Name and | E. coli | | | | | | | | Classification |
| (Sample ID) | Strain | O157 | O26 | O111 | O103 | O121 | O145 | O45 | Family |
| P1 (C-1) | O157 | +++ | − | − | − | − | +++ | ++ | Myoviridae |
| P2 (C-2) | O157 | +++ | − | − | − | − | +++ | ++ | Myoviridae |
| P3 (C-3) | O157 | +++ | − | − | − | − | +++ | ++ | Siphoviridae |
| P4 (C-4) | O157 | +++ | − | − | − | − | +++ | ++ | Siphoviridae |
| P5 (C-5) | O157 | +++ | − | − | − | − | +++ | ++ | Myoviridae |
| P6 (D-2) | O157 | +++ | − | − | − | − | +++ | ++ | Siphoviridae |
| P7 (G-5) | O157 | +++ | − | − | − | − | +++ | ++ | Siphoviridae |
| P8 (A-7) | O121 | ++ | − | − | − | +++ | − | ++ | Myoviridae |
| P9 (A-7) | O45 | ++ | − | − | − | − | − | +++ | Tectiviridae |
| P10 (A-1) | O26 | | ++ | − | − | − | − | − | Myoviridae |
| P11 (A-5) | O26 | | +++ | − | − | − | − | − | Siphoviridae |
| P12 (D-2) | O26 | | +++ | − | − | − | − | − | Siphoviridae |
| P13 (D-5) | O26 | | +++ | − | − | − | − | − | Myoviridae |
| P14 (I-1) | O111 | | − | +++ | − | − | +++ | − | Siphoviridae |
| P15 (I-2) | O111 | | − | +++ | − | − | +++ | − | Siphoviridae |
| P16 (I-4) | O111 | | − | +++ | − | − | +++ | − | Siphoviridae |
| P17 (I-5) | O111 | | − | +++ | − | − | +++ | − | Siphoviridae |
| P18 (I-1) | O103 | | − | − | +++ | − | − | − | Myoviridae |
| P19 (I-2) | O103 | | − | − | +++ | − | − | − | Myoviridae |
| P20 (I-3) | O103 | | − | − | +++ | − | − | − | Siphoviridae |
| P21 (I-4) | O103 | | − | − | +++ | − | − | − | Myoviridae |
| P22 (I-5) | O103 | | − | − | +++ | − | − | − | Myoviridae |
| J-1 (D-1) | O121 | | − | − | − | +++ | − | − | Myoviridae |
| J-2 (D-2) | O121 | | − | − | − | +++ | − | − | Myoviridae |
| J-3 (D-3) | O121 | | − | − | − | +++ | − | − | Myoviridae |
| J-4 (B-1) | O121 | | ++ | − | − | +++ | − | − | Myoviridae |
| J-5 (B-3) | O121 | | ++ | − | − | +++ | − | − | Myoviridae |
| J-6 (B-4) | O121 | | ++ | − | − | +++ | − | − | Myoviridae |
| J-7 (B-5) | O121 | | ++ | − | − | +++ | − | − | Myoviridae |
| J-8 (I-2) | O121 | | − | − | − | +++ | − | − | Myoviridae |
| J-9 (I-3) | O121 | | − | − | − | +++ | − | − | Myoviridae |
| J-10 (I-4) | O121 | | − | − | − | +++ | − | − | Myoviridae |
| J-1l (D-1) | O45 | | − | − | − | − | − | +++ | Myoviridae |
| J-12 (D-2) | O45 | | − | − | − | − | − | +++ | Myoviridae |
| J-13 (D-3) | O45 | | − | − | − | − | − | +++ | Myoviridae |
| J-14 (D-4) | O45 | | − | − | − | − | | +++ | Myoviridae |
| J-15 (D-5) | O45 | | − | − | − | − | − | +++ | Myoviridae |
| J-16 (B-1) | O145 | | − | − | ++ | − | ++ | − | Myoviridae |
| J-17 (B-2) | O145 | | − | − | ++ | − | +++ | + | Myoviridae |
| J-18 (B-3) | O145 | | − | − | ++ | − | +++ | + | Myoviridae |
| J-19 (B-4) | O145 | | − | − | ++ | − | +++ | + | Myoviridae |
| J-20 (B-5) | O145 | | − | − | − | − | +++ | − | Myoviridae |
| J-21 (D-1) | O145 | | − | − | − | − | +++ | − | Myoviridae |
| J-22 (D-2) | O145 | | − | − | ++ | − | +++ | + | Myoviridae |
| J-23 (D-3) | O145 | | − | − | +++ | − | +++ | + | Myoviridae |
| J-24 (D-4) | O145 | | − | − | +++ | − | +++ | + | Myoviridae |
| J-25 (D-5) | O145 | | − | − | +++ | − | +++ | − | Myoviridae |
| J-26 (I-1) | O145 | | − | − | ++ | − | ++ | + | Myoviridae |
| J-27 (I-2) | O145 | | − | − | ++ | − | ++ | + | Myoviridae |
| J-28 (I-3) | O145 | | − | − | +++ | − | ++ | + | Myoviridae |
| J-29 (I-4) | O145 | | − | − | +++ | − | ++ | + | Myoviridae |
| J-30 (I-5) | O145 | | − | − | +++ | − | ++ | + | Myoviridae |

Very strong inhibition: (+++)
Strong inhibition: (++)
Weak inhibition: (+)
No inhibition: (−)

TABLE 4
Thermal Stability at 40° C.

| | 0 | 10 | 20 | 30 | 40 | 50 | 60 |
|---|---|---|---|---|---|---|---|
| | min | mins | mins | mins | mins | mins | mins |
| P1 O157 | 6.8 | 8.2 | 6.7 | 7.2 | 6.8 | 6.6 | 6.3 |
| P2 O157 | 6.8 | 8.2 | 7.6 | 7.3 | 6.6 | 7.7 | 7.3 |
| P3 O157 | 8.8 | 7.4 | 7.2 | 7.2 | 6.5 | 8.1 | 8.1 |
| P4 O157 | 9.0 | 8.1 | 8.3 | 7.3 | 7.5 | 8.0 | 7.8 |
| P5 O157 | 8.7 | 6.4 | 6.6 | 7.2 | 6.1 | 6.1 | 7.5 |
| P6 O157 | 8.9 | 8.3 | 7.3 | 7.3 | 7.8 | 6.8 | 7.5 |
| P7 O157 | 8.7 | 8.5 | 7.4 | 7.6 | 8.2 | 8.0 | 7.6 |
| P8 O121 | 8.7 | 7.9 | 7.9 | 7.9 | 7.8 | 7.9 | 7.9 |
| P9 O45 | 8.4 | 7.8 | 6.7 | 6.8 | 8.2 | 7.7 | 8.1 |
| P11 O26 | 5.2 | 5.3 | 5.5 | 5.2 | 5.0 | 5.1 | 5.0 |
| P12 O26 | 6.7 | 6.8 | 7.3 | 7.2 | 7.0 | 7.3 | 7.1 |
| P13 O26 | 6.5 | 6.6 | 6.2 | 6.3 | 6.2 | 6.2 | 6.3 |
| P14 O111 | 6.0 | 6.1 | 5.8 | 5.9 | 5.9 | 5.8 | 5.9 |
| P16 O111 | 7.3 | 6.8 | 6.9 | 6.9 | 7.0 | 6.8 | 7.0 |
| P17 O111 | 5.8 | 6.0 | 5.7 | 5.6 | 5.5 | 5.5 | 5.6 |
| P19 O103 | 7.2 | 6.9 | 6.7 | 7.1 | 6.8 | 6.7 | 6.9 |
| P21 O103 | 7.2 | 7.2 | 6.8 | 7.1 | 6.9 | 6.9 | 6.9 |
| P22 O103 | 6.8 | 6.9 | 7.4 | 7.2 | 7.3 | 7.3 | 7.3 |
| J4 O121 | 8.1 | 8.1 | 7.9 | 8.1 | 8.1 | 8.0 | 8.1 |
| J7 O121 | 8.1 | 7.9 | 8.1 | 8.1 | 8.1 | 8.0 | 8.1 |
| J14 O45 | 8.0 | 8.0 | 8.1 | 8.0 | 8.1 | 8.1 | 8.2 |
| J15 O45 | 8.9 | 8.9 | 8.9 | 8.9 | 8.9 | 8.9 | 8.9 |
| J18 O145 | 5.9 | 6.3 | 6.2 | 6.2 | 5.9 | 6.1 | 6.2 |
| J19 O145 | 5.9 | 5.8 | 5.9 | 5.9 | 5.9 | 5.9 | 5.9 |
| J25 O145 | 6.3 | 6.4 | 6.3 | 6.3 | 6.2 | 6.1 | 6.0 |
| J30 O145 | 6.3 | 6.3 | 6.2 | 6.3 | 6.2 | 6.1 | 6.0 |

TABLE 5
Thermal Stability at 60° C.

| | 0 | 10 | 20 | 30 | 40 | 50 | 60 |
|---|---|---|---|---|---|---|---|
| | min | mins | mins | mins | mins | mins | mins |
| P1 O157 | 8.0 | 8.0 | 7.3 | 7.1 | 7.4 | 7.3 | 7.9 |
| P2 O157 | 7.9 | 8.2 | 7.6 | 7.4 | 7.7 | 7.6 | 7.5 |
| P3 O157 | 7.9 | 7.5 | 8.3 | 7.2 | 7.5 | 8.2 | 8.2 |
| P4 O157 | 7.7 | 6.9 | 7.1 | 7.0 | 7.3 | 6.5 | 7.1 |
| P5 O157 | 7.8 | 8.2 | 7.6 | 7.2 | 7.4 | 7.1 | 7.2 |
| P6 O157 | 8.6 | 8.3 | 8.0 | 7.8 | 7.8 | 7.5 | 8.0 |
| P7 O157 | 7.4 | 7.5 | 7.6 | 7.8 | 7.7 | 7.2 | 7.5 |
| P8 O121 | 8.9 | 8.4 | 7.9 | 7.7 | 7.3 | 6.6 | 6.6 |
| P9 045 | 7.6 | 7.6 | 7.2 | 7.2 | 7.0 | 7.2 | 7.2 |
| P11 026 | 5.2 | 5.2 | 5.4 | 4.6 | 4.5 | 4.5 | 4.5 |
| P12 026 | 8.0 | 8.1 | 7.5 | 7.4 | 7.6 | 7.5 | 7.3 |
| P13 026 | 6.6 | 6.6 | 6.4 | 6.6 | 6.4 | 6.4 | 6.2 |
| P14 O111 | 6.1 | 6.1 | 5.8 | 5.6 | 5.9 | 5.5 | 5.3 |
| P16 O111 | 7.7 | 7.5 | 7.1 | 6.5 | 7.2 | 7.2 | 6.9 |
| P17 O111 | 5.8 | 5.9 | 5.5 | 5.2 | 5.1 | 5.3 | 4.8 |
| P19 O103 | 7.1 | 5.6 | 2.1 | 0.0 | 0.0 | 0.0 | 0.0 |
| P21 O103 | 7.2 | 1.9 | 2.0 | 0.0 | 0.0 | 0.0 | 0.0 |
| P22 O103 | 7.2 | 3.8 | 3.7 | 0.0 | 0.0 | 0.0 | 0.0 |
| J4 O121 | 8.3 | 8.1 | 7.8 | 7.6 | 7.7 | 7.2 | 7.0 |
| J7 O121 | 8.3 | 8.2 | 7.7 | 7.5 | 7.7 | 7.1 | 7.0 |
| J14 O45 | 9.2 | 9.2 | 8.8 | 9.2 | 8.8 | 8.2 | 8.0 |
| J15 O45 | 8.9 | 8.9 | 8.9 | 8.6 | 8.7 | 8.0 | 8.0 |
| J18 O145 | 5.9 | 5.1 | 5.1 | 5.0 | 5.0 | 5.0 | 4.8 |
| J19 O145 | 6.1 | 5.7 | 5.4 | 5.3 | 5.3 | 5.2 | 5.0 |
| J25 O145 | 6.1 | 5.4 | 5.2 | 5.2 | 5.0 | 4.9 | 4.6 |
| J30 O145 | 6.0 | 5.4 | 5.3 | 5.3 | 5.1 | 5.0 | 4.8 |

TABLE 6
Thermal Stability at 70° C.

| | 0 | 10 | 20 | 30 | 40 | 50 | 60 |
|---|---|---|---|---|---|---|---|
| | min | mins | mins | mins | mins | mins | mins |
| P1 O157 | 8.9 | 0.0 | 0.0 | 0.0 | 0.0 | 0.0 | 0.0 |
| P2 O157 | 7.6 | 0.0 | 0.0 | 0.0 | 0.0 | 0.0 | 0.0 |
| P3 O157 | 8.4 | 1.8 | 0.0 | 0.0 | 0.0 | 0.0 | 0.0 |
| P4 O157 | 8.5 | 1.3 | 0.0 | 0.0 | 0.0 | 0.0 | 0.0 |
| P5 O157 | 8.3 | 5.2 | 0.0 | 0.0 | 0.0 | 0.0 | 0.0 |
| P6 O157 | 8.5 | 2.6 | 0.0 | 0.0 | 0.0 | 0.0 | 0.0 |
| P7 O157 | 8.3 | 5.8 | 0.0 | 0.0 | 0.0 | 0.0 | 0.0 |
| P8 O121 | 8.6 | 7.1 | 6.4 | 5.5 | 4.5 | 4.5 | 4.5 |
| P9 O45 | 9.0 | 7.0 | 7.2 | 0.0 | 0.0 | 0.0 | 0.0 |
| P11 O26 | 5.1 | 4.3 | 3.8 | 3.3 | 3.1 | 2.9 | 2.7 |
| P12 O26 | 8.1 | 7.3 | 6.0 | 5.5 | 4.4 | 4.7 | 3.3 |
| P13 O26 | 6.71 | 6.33 | 6.31 | 6.35 | 4.92 | 4.55 | 4.16 |
| P14 O111 | 6.2 | 4.4 | 0.0 | 0.0 | 0.0 | 0.0 | 0.0 |
| P16 O111 | 8.1 | 4.2 | 2.7 | 2.8 | 2.5 | 0.0 | 0.0 |
| P17 O111 | 6.0 | 3.9 | 0.0 | 0.0 | 0.0 | 0.0 | 0.0 |
| P19 O103 | 7.0 | 0.0 | 0.0 | 0.0 | 0.0 | 0.0 | 0.0 |
| P21 O103 | 7.0 | 2.2 | 0.0 | 0.0 | 0.0 | 0.0 | 0.0 |
| P22 O103 | 8.4 | 2.6 | 0.0 | 0.0 | 0.0 | 0.0 | 0.0 |
| J4 O121 | 8.3 | 6.3 | 5.6 | 3.7 | 3.6 | 2.7 | 2.6 |
| J7 O121 | 8.2 | 6.4 | 5.3 | 5.0 | 3.7 | 3.2 | 3.3 |
| J14 O45 | 9.0 | 4.2 | 4.0 | 3.0 | 0.0 | 0.0 | 0.0 |
| J15 O45 | 9.2 | 6.4 | 5.1 | 2.6 | 2.2 | 0.9 | 2.3 |
| J18 O145 | 5.6 | 2.7 | 3.0 | 2.3 | 1.2 | 1.1 | 0.0 |
| J19 O145 | 5.7 | 2.2 | 1.5 | 1.1 | 0.0 | 0.0 | 0.0 |
| J25 O145 | 6.0 | 2.3 | 0.0 | 0.0 | 0.0 | 0.0 | 0.0 |
| J30 O145 | 5.8 | 0.0 | 0.0 | 0.0 | 0.0 | 0.0 | 0.0 |

TABLE 7
Thermal Stability at 90° C.

| | 0 | 10 | 20 | 30 | 40 | 50 | 60 |
|---|---|---|---|---|---|---|---|
| | min | mins | mins | mins | mins | mins | mins |
| P1 O157 | 7.2 | 0.0 | 0.0 | 0.0 | 0.0 | 0.0 | 0.0 |
| P2 O157 | 7.5 | 0.0 | 0.0 | 0.0 | 0.0 | 0.0 | 0.0 |
| P3 O157 | 8.4 | 0.0 | 0.0 | 0.0 | 0.0 | 0.0 | 0.0 |
| P4 O157 | 8.5 | 0.0 | 0.0 | 0.0 | 0.0 | 0.0 | 0.0 |
| P5 O157 | 8.4 | 0.9 | 0.0 | 0.0 | 0.0 | 0.0 | 0.0 |
| P6 O157 | 8.5 | 0.0 | 0.0 | 0.0 | 0.0 | 0.0 | 0.0 |
| P7 O157 | 8.4 | 0.0 | 0.0 | 0.0 | 0.0 | 0.0 | 0.0 |
| P8 O121 | 8.4 | 1.7 | 1.5 | 1.4 | 1.5 | 1.5 | 1.3 |
| P9 O45 | 8.1 | 0.0 | 0.0 | 0.0 | 0.0 | 0.0 | 0.0 |
| P11 O26 | 5.1 | 1.6 | 0.7 | 0.0 | 0.0 | 0.0 | 0.0 |
| P12 O26 | 7.6 | 3.0 | 0.0 | 0.0 | 0.0 | 0.0 | 0.0 |
| P13 O26 | 6.7 | 2.8 | 2.1 | 1.7 | 1.4 | 2.0 | 2.0 |
| P14 O111 | 6.2 | 2.5 | 1.1 | 0.0 | 0.0 | 0.0 | 0.0 |
| P16 O111 | 7.6 | 0.0 | 0.0 | 0.0 | 0.0 | 0.0 | 0.0 |
| P17 O111 | 5.5 | 0.0 | 0.0 | 0.0 | 0.0 | 0.0 | 0.0 |
| P19 O103 | 7.0 | 0.0 | 0.0 | 0.0 | 0.0 | 0.0 | 0.0 |
| P21 O103 | 7.0 | 0.0 | 0.0 | 0.0 | 0.0 | 0.0 | 0.0 |
| P22 O103 | 8.9 | 0.0 | 0.0 | 0.0 | 0.0 | 0.0 | 0.0 |
| J4 O121 | 8.1 | 3.5 | 2.0 | 0.0 | 0.0 | 0.0 | 0.0 |
| J7 O121 | 8.2 | 2.0 | 1.1 | 0.0 | 0.0 | 0.0 | 0.0 |
| J14 O45 | 9.2 | 2.9 | 0.0 | 0.0 | 0.0 | 0.0 | 0.0 |
| J15 O45 | 8.7 | 0.0 | 0.0 | 0.0 | 0.0 | 0.0 | 0.0 |
| J18 O145 | 5.7 | 0.0 | 0.0 | 0.0 | 0.0 | 0.0 | 0.0 |
| J19 O145 | 6.1 | 0.0 | 0.0 | 0.0 | 0.0 | 0.0 | 0.0 |
| J25 O145 | 5.5 | 0.0 | 0.0 | 0.0 | 0.0 | 0.0 | 0.0 |
| J30 O145 | 5.5 | 0.0 | 0.0 | 0.0 | 0.0 | 0.0 | 0.0 |

TABLE 8
pH Stability

pH

| | Time | | 1 | 2 | 5 | 7 | 9 | 11 |
|---|---|---|---|---|---|---|---|---|
| P1 O157 | 0 | hr | 6.4 | 7.1 | 7.6 | 8.0 | 7.7 | 7.5 |
| | 1 | hr | 0.0 | 3.4 | 6.5 | 7.0 | 7.0 | 5.8 |
| | 2 | hr | 0.0 | 3.4 | 6.1 | 7.5 | 7.3 | 6.4 |
| | 4 | hr | 0.0 | 3.4 | 5.9 | 7.3 | 7.7 | 6.7 |
| | 6 | hr | 0.0 | 3.6 | 6.2 | 7.2 | 7.5 | 6.5 |
| | 12 | hr | 0.0 | 3.6 | 7.2 | 7.3 | 7.1 | 6.4 |
| | 24 | hr | 0.0 | 3.6 | 7.3 | 7.2 | 7.5 | 4.7 |
| P2 O157 | 0 | hr | 6.1 | 5.2 | 7.5 | 7.6 | 7.7 | 6.6 |
| | 1 | hr | 4.8 | 3.6 | 6.7 | 6.1 | 6.9 | 6.2 |
| | 2 | hr | 4.8 | 3.6 | 6.0 | 6.1 | 7.0 | 6.3 |
| | 4 | hr | 4.7 | 3.3 | 7.3 | 6.9 | 7.0 | 6.4 |
| | 6 | hr | 4.7 | 3.3 | 5.9 | 6.8 | 7.1 | 5.5 |
| | 12 | hr | 4.6 | 3.3 | 7.3 | 7.4 | 7.1 | 4.3 |
| | 24 | hr | 4.5 | 3.3 | 7.3 | 7.4 | 7.4 | 3.3 |
| P3 O157 | 0 | hr | 7.2 | 6.2 | 7.7 | 7.6 | 7.6 | 7.9 |
| | 1 | hr | 6.5 | 6.0 | 7.8 | 7.3 | 8.1 | 7.2 |
| | 2 | hr | 0.0 | 6.5 | 7.7 | 7.5 | 6.7 | 6.8 |
| | 4 | hr | 0.0 | 5.4 | 7.8 | 7.4 | 7.2 | 7.5 |
| | 6 | hr | 0.0 | 5.3 | 7.8 | 6.9 | 7.3 | 7.8 |
| | 12 | hr | 0.0 | 5.5 | 7.7 | 7.3 | 7.5 | 6.6 |
| | 24 | hr | 0.0 | 5.6 | 7.6 | 7.6 | 7.5 | 6.2 |
| P4 O157 | 0 | hr | 5.8 | 7.0 | 7.5 | 7.2 | 7.8 | 7.3 |
| | 1 | hr | 0.0 | 5.1 | 6.8 | 7.3 | 7.2 | 7.3 |
| | 2 | hr | 0.0 | 4.0 | 6.7 | 7.1 | 7.3 | 6.3 |
| | 4 | hr | 0.0 | 3.8 | 7.2 | 7.2 | 7.2 | 6.3 |
| | 6 | hr | 0.0 | 4.2 | 6.9 | 7.2 | 7.5 | 6.0 |
| | 12 | hr | 0.0 | 3.7 | 7.3 | 7.2 | 7.4 | 5.4 |
| | 24 | hr | 0.0 | 4.2 | 6.7 | 6.8 | 7.3 | 5.1 |
| P5 O157 | 0 | hr | 6.2 | 6.4 | 7.3 | 7.0 | 7.6 | 6.7 |
| | 1 | hr | 5.5 | 5.5 | 7.2 | 7.1 | 6.8 | 6.1 |
| | 2 | hr | 5.5 | 5.3 | 6.3 | 6.3 | 7.2 | 6.1 |
| | 4 | hr | 5.5 | 4.6 | 6.1 | 6.0 | 6.9 | 5.6 |
| | 6 | hr | 5.3 | 4.6 | 6.0 | 6.0 | 6.8 | 5.5 |
| | 12 | hr | 4.8 | 4.6 | 7.6 | 7.3 | 7.5 | 4.8 |
| | 24 | hr | 4.4 | 4.8 | 7.3 | 7.4 | 6.9 | 0.0 |
| P6 O157 | 0 | hr | 7.5 | 6.5 | 7.5 | 7.0 | 8.1 | 7.3 |
| | 1 | hr | 6.3 | 5.5 | 7.3 | 7.3 | 7.4 | 7.2 |
| | 2 | hr | 6.3 | 5.3 | 7.2 | 7.2 | 7.3 | 6.7 |
| | 4 | hr | 6.3 | 5.2 | 7.0 | 7.4 | 7.2 | 6.4 |
| | 6 | hr | 6.2 | 4.6 | 7.5 | 7.5 | 7.3 | 6.5 |
| | 12 | hr | 6.1 | 4.6 | 7.4 | 7.4 | 7.5 | 5.7 |
| | 24 | hr | 5.8 | 4.9 | 6.9 | 6.7 | 6.9 | 4.8 |
| P7 O157 | 0 | hr | 6.4 | 6.8 | 7.5 | 8.0 | 8.9 | 6.8 |
| | 1 | hr | 0.0 | 5.8 | 7.6 | 6.9 | 7.9 | 6.2 |
| | 2 | hr | 0.0 | 5.5 | 7.7 | 6.9 | 7.9 | 7.0 |
| | 4 | hr | 0.0 | 5.4 | 7.8 | 7.3 | 7.8 | 5.9 |
| | 6 | hr | 0.0 | 5.3 | 7.9 | 7.6 | 7.7 | 5.1 |
| | 12 | hr | 0.0 | 5.3 | 7.3 | 7.4 | 7.7 | 6.0 |
| | 24 | hr | 0.0 | 5.2 | 7.7 | 6.0 | 7.0 | 6.4 |
| P8 O121 | 0 | hr | 7.6 | 7.3 | 8.5 | 8.2 | 7.2 | 8.1 |
| | 1 | hr | 7.5 | 6.3 | 8.4 | 7.9 | 7.1 | 7.0 |
| | 2 | hr | 7.5 | 6.3 | 8.3 | 8.2 | 7.0 | 6.9 |
| | 4 | hr | 7.4 | 6.3 | 8.4 | 8.1 | 7.4 | 6.9 |
| | 6 | hr | 7.1 | 6.3 | 8.3 | 8.0 | 7.2 | 6.8 |
| | 12 | hr | 6.6 | 6.1 | 8.0 | 8.0 | 7.4 | 5.8 |
| | 24 | hr | 6.3 | 6.0 | 7.8 | 7.9 | 7.6 | 6.1 |
| P9 O45 | 0 | hr | 6.3 | 6.5 | 7.7 | 7.8 | 7.3 | 8.0 |
| | 1 | hr | 0.0 | 5.9 | 7.3 | 7.3 | 7.5 | 7.6 |
| | 2 | hr | 0.0 | 5.9 | 7.2 | 7.3 | 7.2 | 7.4 |
| | 4 | hr | 0.0 | 5.9 | 7.0 | 7.5 | 7.3 | 6.8 |
| | 6 | hr | 0.0 | 5.7 | 7.3 | 7.6 | 7.3 | 6.5 |
| | 12 | hr | 0.0 | 6.3 | 7.5 | 7.6 | 7.3 | 5.5 |
| | 24 | hr | 0.0 | 5.3 | 7.4 | 7.5 | 7.1 | 5.4 |
| P11 O26 | 0 | hr | 6.6 | 7.4 | 8.0 | 7.9 | 7.9 | 7.3 |
| | 1 | hr | 0 | 3.6 | 7.9 | 7.8 | 7.8 | 7.7 |
| | 2 | hr | 0 | 2.6 | 7.6 | 7.5 | 7.3 | 7.2 |
| | 4 | hr | 0 | 2.5 | 7.2 | 7.3 | 7.3 | 7.4 |
| | 6 | hr | 0 | 2.5 | 7.1 | 7.1 | 7.4 | 6.5 |
| | 12 | hr | 0 | 2.1 | 7.1 | 7.2 | 7.1 | 6.4 |
| | 24 | hr | 0 | 1.9 | 7.1 | 7.3 | 7.4 | 5.6 |
| P12 O26 | 0 | hr | 7.3 | 7.3 | 7.3 | 7.4 | 7.3 | 7.3 |
| | 1 | hr | 0.0 | 0.0 | 6.9 | 7.4 | 7.3 | 7.0 |
| | 2 | hr | 0.0 | 0.0 | 7.6 | 7.3 | 7.0 | 7.1 |
| | 4 | hr | 0.0 | 0.0 | 7.6 | 7.5 | 6.7 | 6.9 |
| | 6 | hr | 0.0 | 0.0 | 7.2 | 7.4 | 6.7 | 6.4 |
| | 12 | hr | 0.0 | 0.0 | 6.8 | 7.5 | 6.3 | 6.0 |
| | 24 | hr | 0.0 | 0.0 | 6.4 | 6.7 | 5.7 | 3.9 |
| P13 O26 | 0 | hr | 4.4 | 4.8 | 5.6 | 6.0 | 5.3 | 5.4 |
| | 1 | hr | 4.0 | 3.7 | 5.6 | 6.0 | 5.4 | 5.5 |
| | 2 | hr | 4.3 | 2.3 | 5.6 | 5.6 | 5.6 | 5.4 |
| | 4 | hr | 2.4 | 1.6 | 5.6 | 5.5 | 5.6 | 5.4 |
| | 6 | hr | 0.0 | 0.0 | 5.4 | 5.2 | 4.5 | 4.7 |
| | 12 | hr | 0.0 | 0.0 | 4.5 | 5.0 | 4.2 | 4.2 |
| | 24 | hr | 0.0 | 0.0 | 4.4 | 5.3 | 4.2 | 3.5 |
| P14 O111 | 0 | hr | 4.2 | 5.1 | 5.3 | 5.3 | 5.2 | 5.3 |
| | 1 | hr | 3.9 | 3.4 | 5.4 | 5.2 | 5.1 | 5.2 |
| | 2 | hr | 0.0 | 2.1 | 5.4 | 5.2 | 5.2 | 5.3 |
| | 4 | hr | 0.0 | 2.1 | 5.2 | 4.7 | 4.6 | 4.8 |
| | 6 | hr | 0.0 | 0.0 | 4.8 | 4.7 | 4.5 | 4.9 |
| | 12 | hr | 0.0 | 0.0 | 4.4 | 4.5 | 4.6 | 4.6 |
| | 24 | hr | 0.0 | 0.0 | 4.4 | 4.4 | 4.4 | 4.2 |
| P16 O111 | 0 | hr | 7.5 | 7.5 | 7.5 | 7.7 | 7.5 | 7.4 |
| | 1 | hr | 0.0 | 0.0 | 7.4 | 7.5 | 7.2 | 7.0 |
| | 2 | hr | 0.0 | 0.0 | 7.8 | 7.6 | 7.1 | 7.3 |
| | 4 | hr | 0.0 | 0.0 | 7.6 | 7.6 | 6.3 | 6.8 |
| | 6 | hr | 0.0 | 0.0 | 7.5 | 7.2 | 6.3 | 5.8 |
| | 12 | hr | 0.0 | 0.0 | 6.9 | 7.1 | 6.4 | 5.5 |
| | 24 | hr | 0.0 | 0.0 | 6.3 | 6.3 | 4.9 | 4.1 |
| P17 O111 | 0 | hr | 5.6 | 6.2 | 7.3 | 7.5 | 7.6 | 7.2 |
| | 1 | hr | 0.0 | 1.9 | 7.2 | 7.7 | 7.5 | 7.1 |
| | 2 | hr | 0.0 | 2.0 | 7.1 | 6.4 | 6.5 | 5.2 |
| | 4 | hr | 0.0 | 0.0 | 5.7 | 6.2 | 6.2 | 5.2 |
| | 6 | hr | 0.0 | 0.0 | 6.4 | 6.5 | 6.5 | 4.4 |
| | 12 | hr | 0.0 | 0.0 | 5.7 | 6.4 | 6.1 | 4.1 |
| | 24 | hr | 0.0 | 0.0 | 6.1 | 5.9 | 6.1 | 3.6 |
| P19 O103 | 0 | hr | 8.0 | 5.4 | 7.2 | 7.5 | 7.4 | 7.8 |
| | 1 | hr | 0.0 | 4.5 | 6.7 | 7.4 | 7.1 | 5.5 |
| | 2 | hr | 0.0 | 3.3 | 6.4 | 6.8 | 6.5 | 4.6 |
| | 4 | hr | 0.0 | 3.0 | 6.5 | 6.8 | 6.1 | 3.3 |
| | 6 | hr | 0.0 | 0.0 | 6.5 | 6.7 | 6.1 | 3.5 |
| | 12 | hr | 0.0 | 0.0 | 5.9 | 6.4 | 5.5 | 0.0 |
| | 24 | hr | 0.0 | 0.0 | 6.6 | 6.3 | 5.4 | 0.0 |
| P21 O103 | 0 | hr | 4.2 | 5.0 | 5.9 | 6.2 | 6.0 | 5.6 |
| | 1 | hr | 2.3 | 0.0 | 5.8 | 6.0 | 5.6 | 5.5 |
| | 2 | hr | 0.0 | 0.0 | 5.8 | 5.9 | 5.9 | 5.7 |
| | 4 | hr | 0.0 | 0.0 | 5.5 | 5.5 | 5.3 | 5.3 |
| | 6 | hr | 0.0 | 0.0 | 5.4 | 5.6 | 5.4 | 5.3 |
| | 12 | hr | 0.0 | 0.0 | 5.3 | 5.1 | 5.1 | 5.1 |
| | 24 | hr | 0.0 | 0.0 | 5.0 | 5.0 | 4.0 | 4.9 |
| P22 O103 | 0 | hr | 7.8 | 7.8 | 7.8 | 7.7 | 7.7 | 7.5 |
| | 1 | hr | 0.0 | 0.0 | 7.5 | 7.5 | 7.5 | 7.3 |
| | 2 | hr | 0.0 | 0.0 | 7.9 | 7.5 | 7.4 | 7.3 |
| | 4 | hr | 0.0 | 0.0 | 7.4 | 7.6 | 7.1 | 6.1 |
| | 6 | hr | 0.0 | 0.0 | 7.0 | 7.4 | 6.7 | 6.4 |
| | 12 | hr | 0.0 | 0.0 | 7.4 | 7.6 | 6.1 | 5.5 |
| | 24 | hr | 0.0 | 0.0 | 7.0 | 6.3 | 5.3 | 4.2 |
| J4 O121 | 0 | hr | 5.5 | 7.1 | 7.1 | 7.2 | 7.5 | 7.0 |
| | 1 | hr | 0.0 | 0.0 | 7.2 | 7.2 | 7.5 | 7.1 |
| | 2 | hr | 0.0 | 0.0 | 7.2 | 7.2 | 8.0 | 7.1 |
| | 4 | hr | 0.0 | 0.0 | 7.1 | 7.1 | 7.2 | 6.8 |
| | 6 | hr | 0.0 | 0.0 | 7.1 | 7.1 | 7.4 | 6.5 |
| | 12 | hr | 0.0 | 0.0 | 7.1 | 7.0 | 7.3 | 6.2 |
| | 24 | hr | 0.0 | 0.0 | 7.1 | 6.9 | 7.0 | 5.7 |
| J7 O121 | 0 | hr | 8.6 | 7.6 | 9.3 | 9.4 | 9.2 | 9.4 |
| | 1 | hr | 0.0 | 2.5 | 9.3 | 9.7 | 9.1 | 8.1 |
| | 2 | hr | 0.0 | 0.0 | 9.3 | 8.6 | 8.6 | 7.9 |
| | 4 | hr | 0.0 | 0.0 | 8.4 | 8.8 | 8.6 | 8.0 |
| | 6 | hr | 0.0 | 0.0 | 8.6 | 8.6 | 8.4 | 7.3 |
| | 12 | hr | 0.0 | 0.0 | 8.6 | 8.6 | 8.6 | 7.6 |
| | 24 | hr | 0.0 | 0.0 | 8.5 | 8.5 | 8.2 | 7.3 |
| J14 O45 | 0 | hr | 8.1 | 8.1 | 8.1 | 8.2 | 8.5 | 7.9 |
| | 1 | hr | 0.0 | 0.0 | 7.9 | 7.5 | 7.5 | 7.4 |
| | 2 | hr | 0.0 | 0.0 | 8.6 | 8.2 | 7.7 | 7.4 |
| | 4 | hr | 0.0 | 0.0 | 8.8 | 8.0 | 7.4 | 6.3 |
| | 6 | hr | 0.0 | 0.0 | 7.7 | 7.9 | 7.3 | 6.7 |
| | 12 | hr | 0.0 | 0.0 | 7.6 | 8.0 | 7.2 | 6.8 |
| | 24 | hr | 0.0 | 0.0 | 7.2 | 7.1 | 4.5 | 3.8 |
| J15 O45 | 0 | hr | 8.9 | 9.4 | 9.7 | 9.8 | 9.6 | 10.8 |
| | 1 | hr | 0.0 | 7.3 | 9.7 | 9.8 | 9.8 | 9.9 |
| | 2 | hr | 0.0 | 7.1 | 9.7 | 9.4 | 9.2 | 9.1 |
| | 4 | hr | 0.0 | 3.0 | 9.3 | 9.5 | 9.4 | 9.0 |
| | 6 | hr | 0.0 | 2.7 | 9.2 | 9.5 | 9.2 | 8.6 |
| | 12 | hr | 0.0 | 2.2 | 9.2 | 9.3 | 9.2 | 8.5 |
| | 24 | hr | 0.0 | 2.2 | 9.3 | 9.4 | 9.2 | 7.1 |
| J18 O145 | 0 | hr | 7.2 | 4.5 | 6.0 | 6.3 | 5.7 | 5.6 |
| | 1 | hr | 0.0 | 2.7 | 6.0 | 6.0 | 5.5 | 5.5 |
| | 2 | hr | 0.0 | 2.9 | 5.7 | 5.3 | 5.7 | 5.1 |
| | 4 | hr | 0.0 | 0.0 | 5.3 | 5.3 | 5.7 | 4.3 |
| | 6 | hr | 0.0 | 0.0 | 5.3 | 5.3 | 5.3 | 4.3 |
| | 12 | hr | 0.0 | 0.0 | 5.3 | 5.4 | 5.5 | 4.0 |
| | 24 | hr | 0.0 | 0.0 | 5.5 | 5.8 | 5.7 | 2.0 |
| J19 O145 | 0 | hr | 5.1 | 5.1 | 4.6 | 4.6 | 4.4 | 6.0 |
| | 1 | hr | 0.0 | 4.4 | 4.9 | 5.0 | 4.6 | 6.1 |
| | 2 | hr | 0.0 | 1.4 | 5.0 | 4.8 | 4.8 | 6.4 |
| | 4 | hr | 0.0 | 0.0 | 5.1 | 4.0 | 4.6 | 5.9 |
| | 6 | hr | 0.0 | 0.0 | 5.0 | 4.4 | 4.3 | 3.9 |
| | 12 | hr | 0.0 | 0.0 | 5.0 | 4.1 | 4.3 | 4.5 |
| | 24 | hr | 0.0 | 0.0 | 4.1 | 3.8 | 3.2 | 3.1 |
| J25 O145 | 0 | hr | 6.3 | 5.7 | 6.1 | 6.1 | 5.6 | 5.3 |
| | 1 | hr | 0.0 | 2.9 | 6.0 | 6.1 | 5.5 | 5.9 |
| | 2 | hr | 0.0 | 2.6 | 6.2 | 5.3 | 5.8 | 5.4 |
| | 4 | hr | 0.0 | 0.0 | 5.6 | 5.4 | 5.5 | 4.8 |
| | 6 | hr | 0.0 | 0.0 | 5.4 | 5.3 | 5.4 | 4.9 |
| | 12 | hr | 0.0 | 0.0 | 5.7 | 5.6 | 5.3 | 4.5 |
| | 24 | hr | 0.0 | 0.0 | 6.0 | 5.7 | 5.9 | 0.9 |
| J30 O145 | 0 | hr | 5.4 | 5.8 | 5.8 | 5.9 | 5.4 | 5.4 |
| | 1 | hr | 1.7 | 2.7 | 5.7 | 5.8 | 5.6 | 5.6 |
| | 2 | hr | 1.7 | 2.8 | 5.3 | 5.2 | 5.5 | 5.2 |
| | 4 | hr | 0.0 | 0.0 | 5.5 | 5.1 | 5.4 | 5.1 |
| | 6 | hr | 0.0 | 0.0 | 5.9 | 5.1 | 5.1 | 5.3 |
| | 12 | hr | 0.0 | 0.0 | 6.0 | 5.5 | 5.2 | 4.6 |
| | 24 | hr | 0.0 | 0.0 | 6.2 | 5.8 | 5.1 | 2.4 |

TABLE 9
Storage Stability at 4° C.

| | 0 day | 1 day | 30 day | 60 day | 90 day |
|---|---|---|---|---|---|
| P1 O157 | 7.3 | 6.8 | 3.6 | 5.9 | 5.8 |
| P2 O157 | 7.5 | 7.0 | 6.2 | 5.9 | 5.9 |
| P3 O157 | 9.0 | 9.1 | 8.3 | 7.5 | 7.6 |
| P4 O157 | 7.4 | 7.9 | 6.2 | 5.4 | 5.5 |
| P5 O157 | 7.6 | 7.7 | 5.9 | 5.3 | 5.3 |
| P6 O157 | 7.9 | 8.4 | 7.5 | 7.3 | 7.7 |
| P7 O157 | 8.9 | 8.8 | 8.5 | 8.6 | 8.9 |
| P8 O121 | 9.1 | 9.2 | 7.5 | 7.1 | 7.6 |
| P9 O45 | 8.0 | 8.5 | 7.2 | 7.2 | 7.2 |
| P11 O26 | 8.5 | 8.6 | 8.6 | 8.4 | 6.7 |
| P12 O26 | 8.0 | 8.4 | 8.2 | 7.8 | 7.3 |
| P13 O26 | 7.6 | 7.4 | 8.2 | 8.4 | 7.1 |
| P14 | 7.3 | 7.6 | 6.7 | 6.4 | 5.6 |
| O111 | | | | | |
| P16 | 7.5 | 8.2 | 7.7 | 7.9 | 8.3 |
| O111 | | | | | |
| P17 | 7.3 | 7.7 | 7.7 | 6.6 | 5.7 |
| O111 | | | | | |
| P19 | 7.3 | 7.7 | 7.8 | 7.5 | 7.4 |
| O103 | | | | | |
| P21 | 7.8 | 7.6 | 7.8 | 7.5 | 7.2 |
| O103 | | | | | |
| P22 | 8.1 | 8.5 | 8.5 | 8.2 | 8.2 |
| O103 | | | | | |
| J4 O121 | 8.5 | 8.7 | 9.6 | 8.1 | 9.4 |
| J7 O121 | 8.8 | 9.4 | 10.3 | 9.4 | 9.9 |
| J14 O121 | 8.7 | 8.9 | 8.7 | 8.7 | 8.1 |
| J15 O45 | 8.6 | 8.8 | 9.6 | 8.9 | 10.7 |
| J18 O145 | 7.1 | 7.1 | 6.6 | 6.4 | 6.3 |
| J19 O145 | 7.2 | 7.2 | 6.6 | 6.0 | 6.2 |
| J25 O145 | 7.3 | 7.0 | 6.9 | 6.4 | 7.1 |
| J30 O145 | 7.1 | 7.3 | 6.7 | 6.1 | 6.6 |

TABLE 10
Storage Stability at −20° C.

| | 0 day | 1 day | 30 day | 60 day | 90 day |
|---|---|---|---|---|---|
| P1 O157 | 7.3 | 5.2 | 3.3 | 1.8 | 3.7 |
| P2 O157 | 7.5 | 6.5 | 3.6 | 1.2 | 1.3 |
| P3 O157 | 9.0 | 7.1 | 6.6 | 5.3 | 5.3 |
| P4 O157 | 7.4 | 6.8 | 6.1 | 5.8 | 5.8 |
| P5 O157 | 7.6 | 6.5 | 3.2 | 2.1 | 1.8 |
| P6 O157 | 7.9 | 7.1 | 7.3 | 6.5 | 6.5 |
| P7 O157 | 8.9 | 7.1 | 4.4 | 3.3 | 4.3 |
| P8 O121 | 9.1 | 9.1 | 7.3 | 5.2 | 5.4 |
| P9 O45 | 8.0 | 7.1 | 7.2 | 6.2 | 6.0 |
| P11 O26 | 7.4 | 7.6 | 7.4 | 7.6 | 7.0 |
| P12 O26 | 7.0 | 8.3 | 7.1 | 7.1 | 6.7 |
| P13 O26 | 7.1 | 7.3 | 6.6 | 6.3 | 6.1 |
| P14 | 7.5 | 7.6 | 8.8 | 6.5 | 6.1 |
| O111 | | | | | |
| P16 | 7.5 | 8.4 | 7.1 | 7.2 | 6.9 |
| O111 | | | | | |
| P17 | 7.8 | 7.5 | 8.9 | 6.3 | 6.1 |
| O111 | | | | | |
| P19 | 8.5 | 6.4 | 3.3 | 1.1 | 0.0 |
| O103 | | | | | |
| P21 | 7.6 | 6.5 | 3.2 | 1.1 | 0.0 |
| O103 | | | | | |
| P22 | 8.1 | 7.3 | 1.5 | 0.0 | 0.0 |
| O103 | | | | | |
| J4 O121 | 8.8 | 7.4 | 7.1 | 5.4 | 5.1 |
| J7 O121 | 8.9 | 7.7 | 6.7 | 5.7 | 5.4 |
| J14 O45 | 8.7 | 6.2 | 4.8 | 4.6 | 0.0 |
| J15 O45 | 8.6 | 8.6 | 4.4 | 2.3 | 3.3 |
| J18 O145 | 7.1 | 7.0 | 6.1 | 4.7 | 4.7 |
| J19 O145 | 7.4 | 6.9 | 5.8 | 4.3 | 4.4 |
| J25 O145 | 7.0 | 6.6 | 6.0 | 4.4 | 4.2 |
| J30 O145 | 7.4 | 7.2 | 6.1 | 4.5 | 4.9 |

TABLE 11
Storage Stability at −80° C.

| | 0 day | 1 day | 30 day | 60 day | 90 day |
|---|---|---|---|---|---|
| P1 O157 | 7.3 | 6.0 | 4.3 | 2.9 | 2.3 |
| P2 O157 | 7.5 | 6.0 | 4.2 | 3.1 | 4.0 |
| P3 O157 | 9.0 | 7.3 | 6.6 | 5.3 | 5.2 |
| P4 O157 | 7.4 | 6.7 | 5.8 | 4.7 | 4.5 |
| P5 O157 | 7.6 | 6.2 | 4.3 | 4.1 | 4.2 |
| P6 O157 | 7.9 | 7.2 | 7.3 | 6.3 | 5.9 |
| P7 O157 | 8.9 | 6.3 | 5.6 | 4.0 | 3.8 |
| P8 O121 | 9.1 | 9.1 | 8.1 | 7.4 | 7.5 |
| P9 O45 | 8.0 | 8.0 | 7.2 | 6.2 | 6.1 |
| P11 O26 | 8.6 | 8.6 | 8.4 | 8.1 | 5.1 |
| P12 O26 | 8.1 | 8.0 | 2.5 | 0.0 | 0.0 |
| P13 O26 | 7.7 | 7.3 | 7.4 | 6.4 | 6.0 |
| P14 O111 | 8.0 | 7.1 | 7.5 | 5.6 | 5.4 |
| P16 O111 | 8.7 | 7.9 | 3.0 | 0.0 | 0.0 |
| P17 O111 | 8.2 | 7.1 | 6.5 | 5.3 | 4.9 |
| P19 O103 | 7.8 | 6.1 | 3.3 | 0.3 | 0.0 |
| P21 O103 | 7.8 | 6.0 | 3.0 | 0.7 | 0.0 |
| P22 O103 | 8.0 | 5.3 | 1.8 | 0.0 | 0.0 |
| J4 O121 | 8.7 | 8.7 | 9.0 | 5.8 | 4.5 |
| J7 O121 | 9.2 | 8.7 | 9.2 | 6.0 | 4.7 |
| J14 O45 | 7.5 | 5.3 | 4.3 | 3.0 | 0.0 |
| J15 O45 | 9.0 | 8.8 | 5.4 | 3.2 | 4.9 |
| J18 O145 | 7.4 | 7.3 | 6.2 | 5.4 | 5.5 |
| J19 O145 | 7.3 | 7.2 | 5.7 | 5.4 | 5.4 |
| J25 O145 | 7.2 | 7.0 | 6.9 | 5.2 | 5.4 |
| J30 O145 | 7.1 | 7.1 | 5.8 | 5.4 | 5.5 |

TABLE 12
Phage adsorption

| | 0 min | 20 mins | 40 mins | 60 mins | 80 mins |
|---|---|---|---|---|---|
| P1 O157 | 5.2 | 3.1 | 2.9 | 2.4 | 2.4 |
| P2 O157 | 4.2 | 2.5 | 2.4 | 2.1 | 1.9 |
| P3 O157 | 5.4 | 3.3 | 3.3 | 2.2 | 2.2 |
| P4 O157 | 5.6 | 2.7 | 3.3 | 2.4 | 2.4 |
| P5 O157 | 5.4 | 3.0 | 2.6 | 2.2 | 2.3 |
| P6 O157 | 7.1 | 4.6 | 4.3 | 4.0 | 3.5 |
| P7 O157 | 5.2 | 3.2 | 2.8 | 2.8 | 2.6 |
| P8 O121 | 6.4 | 4.1 | 3.3 | 3.1 | 2.9 |
| P9 O45 | 6.7 | 5.2 | 4.3 | 4.0 | 3.9 |
| P11 O26 | 5.7 | 5.7 | 5.7 | 5.4 | 5.1 |
| P12 O26 | 5.9 | 5.8 | 5.7 | 5.7 | 5.1 |
| P13 O26 | 6.1 | 5.9 | 5.7 | 5.4 | 5.3 |
| P14 | 4.1 | 3.2 | 3.2 | 2.8 | 2.6 |
| O111 | | | | | |
| P16 | 6.6 | 6.5 | 5.9 | 5.6 | 5.5 |
| O111 | | | | | |
| P17 | 3.1 | 2.8 | 2.9 | 2.5 | 2.5 |
| O111 | | | | | |
| P19 | 5.4 | 5.1 | 4.8 | 4.6 | 4.6 |
| O103 | | | | | |
| P21 | 5.4 | 5.1 | 4.7 | 4.7 | 4.7 |
| O103 | | | | | |
| P22 | 6.8 | 5.7 | 5.6 | 5.3 | 5.3 |
| O103 | | | | | |
| J4 O121 | 7.4 | 7.4 | 7.3 | 7 | 6.9 |
| J7 O121 | 7.4 | 6.9 | 6.7 | 6.6 | 6.3 |
| J14 O45 | 5.6 | 4.5 | 4.6 | 4.6 | 4.8 |
| J15 O45 | 4.1 | 3.1 | 2.8 | 2.8 | 2.5 |
| J18 O145 | 4.1 | 3.1 | 2.8 | 2.8 | 2.5 |
| J19 O145 | 4.1 | 3.1 | 2.2 | 1.7 | 0.9 |
| J25 O145 | 4.4 | 3.6 | 4 | 3.8 | 3.7 |
| J30 O145 | 4.0 | 3.7 | 3.1 | 2.5 | 2.2 |

Table 13a-c. One-Step Growth Kinetics

TABLE 13a

| Time | | P1 O157 | P2 O157 | P3 O157 | P4 O157 | P5 O157 | P6 O157 | P7 O157 | P8 O121 | P9 O45 |
|---|---|---|---|---|---|---|---|---|---|---|
| 0 | min | 4.6 | 4.1 | 3.6 | 5.1 | 4.6 | 6.0 | 5.3 | 5.2 | 6.3 |
| 5 | mins | 4.5 | 4.0 | 3.8 | 5.1 | 4.5 | 5.9 | 5.6 | 5.5 | 6.3 |
| 10 | mins | 4.6 | 4.1 | 3.9 | 5.3 | 4.9 | 6.0 | 5.5 | 5.6 | 6.4 |
| 15 | mins | 4.7 | 4.0 | 4.0 | 5.2 | 5.1 | 6.7 | 5.5 | 5.5 | 6.5 |
| 20 | mins | 4.9 | 4.3 | 4.3 | 5.5 | 5.1 | 6.7 | 6.6 | 5.6 | 6.5 |
| 25 | mins | 5.1 | 4.5 | 4.2 | 6.2 | 5.3 | 6.8 | 6.6 | 6.0 | 6.7 |
| 30 | mins | 6.1 | 4.7 | 4.4 | 6.9 | 5.9 | 7.8 | 6.6 | 7.0 | 7.1 |
| 35 | mins | 5.5 | 4.9 | 4.5 | 7.0 | 6.3 | 7.6 | 6.2 | 7.0 | 7.3 |
| 40 | mins | 6.1 | 5.2 | 4.7 | 6.9 | 6.1 | 7.9 | 7.2 | 6.9 | 8.8 |
| 45 | mins | 6.2 | 5.5 | 4.8 | 7.3 | 6.3 | 8.4 | 7.4 | 7.0 | 8.7 |
| 50 | mins | 7.0 | 5.7 | 4.9 | 7.4 | 7.0 | 8.3 | 7.4 | 7.1 | 8.7 |
| 55 | mins | 6.9 | 6.2 | 5.1 | 7.6 | 7.3 | 8.5 | 7.5 | 7.2 | 8.7 |
| 60 | mins | 7.7 | 6.9 | 5.2 | 7.9 | 7.4 | 8.5 | 7.8 | 8.3 | 8.8 |

TABLE 13b

| Time | | P11 O26 | P12 O26 | P13 O26 | P14 O111 | P16 O111 | P17 O111 | P19 O103 | P21 O103 | P22 O103 |
|---|---|---|---|---|---|---|---|---|---|---|
| 0 | min | 3.6 | 5.6 | 5.3 | 6.7 | 6.2 | 3.6 | 5.1 | 5.5 | 6.8 |
| 5 | mins | 3.6 | 5.6 | 5.3 | 6.7 | 6.2 | 3.6 | 5.1 | 5.6 | 6.8 |
| 10 | mins | 3.8 | 5.7 | 5.3 | 6.9 | 6.3 | 3.7 | 5.3 | 5.6 | 6.9 |
| 15 | mins | 4.1 | 5.8 | 5.3 | 7.2 | 6.5 | 4.1 | 5.4 | 5.6 | 6.9 |
| 20 | mins | 4.4 | 5.9 | 5.4 | 7.3 | 6.6 | 4.4 | 5.5 | 5.6 | 7.0 |
| 25 | mins | 4.6 | 6.2 | 5.4 | 7.4 | 6.8 | 4.9 | 5.6 | 5.7 | 7.0 |
| 30 | mins | 4.8 | 6.2 | 5.5 | 8.3 | 6.8 | 5.3 | 5.8 | 6.0 | 7.0 |
| 35 | mins | 5.0 | 6.6 | 5.5 | 8.5 | 7.0 | 5.4 | 5.9 | 6.1 | 7.0 |
| 40 | mins | 5.2 | 6.7 | 5.8 | 8.8 | 7.1 | 5.5 | 6.0 | 6.5 | 7.0 |
| 45 | mins | 5.8 | 6.8 | 5.9 | 8.9 | 7.2 | 5.6 | 6.2 | 6.7 | 7.4 |
| 50 | mins | 5.8 | 6.9 | 6.1 | 9.0 | 7.3 | 5.7 | 6.3 | 6.9 | 7.7 |
| 55 | mins | 5.8 | 7.0 | 6.2 | 9.2 | 7.4 | 5.9 | 6.4 | 7.0 | 8.0 |
| 60 | mins | 5.9 | 7.1 | 6.3 | 9.2 | 7.4 | 5.9 | 6.4 | 7.3 | 8.0 |

TABLE 13c

| Time | | J4 O121 | J7 O121 | J14 O45 | J15 O45 | J18 O145 | J19 O145 | J25 O145 | J30 O145 |
|---|---|---|---|---|---|---|---|---|---|
| 0 | min | 5.9 | 5.9 | 6.6 | 6.2 | 5.9 | 5.7 | 6.7 | 5.6 |
| 5 | mins | 5.9 | 6.0 | 6.6 | 6.2 | 6.0 | 5.8 | 6.7 | 5.7 |
| 10 | mins | 5.9 | 6.1 | 6.6 | 6.3 | 6.1 | 6.0 | 6.8 | 6.3 |
| 15 | mins | 6.1 | 6.2 | 6.6 | 6.4 | 6.3 | 6.3 | 6.8 | 6.3 |
| 20 | mins | 6.2 | 6.2 | 6.6 | 6.8 | 6.4 | 6.3 | 6.2 | 6.4 |
| 25 | mins | 6.3 | 6.2 | 6.7 | 7.3 | 6.5 | 6.4 | 6.6 | 6.5 |
| 30 | mins | 6.4 | 6.4 | 6.7 | 7.3 | 7.0 | 6.3 | 6.7 | 6.6 |
| 35 | mins | 7.0 | 6.5 | 7.2 | 7.5 | 7.3 | 6.3 | 6.9 | 7.8 |
| 40 | mins | 7.1 | 6.7 | 7.6 | 7.5 | 7.5 | 7.2 | 7.2 | 7.7 |
| 45 | mins | 7.3 | 7.5 | 7.8 | 7.7 | 7.5 | 7.2 | 7.5 | 7.8 |
| 50 | mins | 7.7 | 7.7 | 7.9 | 7.8 | 7.6 | 7.4 | 7.8 | 7.8 |
| 55 | mins | 7.8 | 7.9 | 7.9 | 8.0 | 7.8 | 7.4 | 7.8 | 7.5 |
| 60 | mins | 8.0 | 8.1 | 7.9 | 8.1 | 7.8 | 7.5 | 8.1 | 8.2 |

TABLE 14
Phage Minimum Inhibitory Concentrations against STEC. Minimum
inhibitory concentration of some (17%) phages was 10² PFU and
most of the phages with a weak (+) reaction was 1000 PFU; with
strong inhibition (++) was 10⁴ PFU; and with very strong inhibition
(+++) was 10⁵ for most (83%) of the phages.

| | Phage | | | | | |
|---|---|---|---|---|---|---|
| | Population | 10⁶ | 10⁵ | 10⁴ | 1000 | 100 |
| Phages | (PFU/ml) | PFU | PFU | PFU | PFU | PFU |
| P1-O157 | 7.71 | +++ | ++ | ++ | + | |
| P2-O157 | 6.03 | +++ | +++ | ++ | + | |
| P3-O157 | 7.44 | +++ | ++ | ++ | + | |
| P4-O157 | 7.63 | +++ | ++ | + | + | |
| P5-O157 | 7.83 | +++ | ++ | ++ | + | |
| P6-O157 | 8.21 | +++ | +++ | ++ | + | |
| P7-O157 | 6.78 | +++ | ++ | + | | |
| P8-O121 | 8.50 | +++ | +++ | ++ | + | |
| P9-O45 | 10.38 | +++ | +++ | ++ | + | |
| P10-O26 | 5.92 | +++ | +++ | ++ | + | |
| P11-O26 | 7.38 | +++ | +++ | ++ | + | |
| P12-O26 | 7.43 | +++ | +++ | ++ | ++ | + |
| P13-O26 | 8.01 | +++ | +++ | ++ | + | |
| P14-O111 | 7.03 | +++ | +++ | ++ | + | |
| P15-O111 | 6.14 | +++ | +++ | ++ | + | |
| P16-O111 | 5.83 | +++ | +++ | ++ | + | |
| P17-O111 | 6.21 | +++ | +++ | ++ | + | |
| P18-O103 | 7.03 | +++ | +++ | ++ | + | |
| P19-O103 | 7.34 | +++ | +++ | ++ | + | |
| P20-O103 | 7.46 | +++ | +++ | ++ | + | |
| P21-O103 | 7.38 | +++ | +++ | ++ | + | |
| P22-O103 | 6.64 | +++ | +++ | ++ | + | + |
| J1-O121 | 9.24 | +++ | +++ | ++ | + | + |
| J2-O121 | 8.90 | +++ | +++ | ++ | + | |
| J3-O121 | 8.78 | +++ | +++ | ++ | ++ | + |
| J4-O121 | 10.43 | +++ | +++ | ++ | + | |
| J5-O121 | 8.86 | +++ | ++ | ++ | + | |
| J6-O121 | 8.40 | +++ | +++ | ++ | ++ | |
| J7-O121 | 10.43 | +++ | +++ | ++ | + | |
| J8-O121 | 9.08 | +++ | ++ | ++ | + | |
| J9-O121 | 8.23 | +++ | +++ | ++ | ++ | + |
| J10-O121 | 8.57 | +++ | +++ | ++ | ++ | + |
| J11-O45 | 7.21 | +++ | +++ | ++ | ++ | + |
| J12-O45 | 7.73 | +++ | ++ | ++ | + | |
| J13-O45 | 7.90 | +++ | ++ | ++ | + | |
| J14-O45 | 7.87 | +++ | +++ | ++ | ++ | + |
| J15-O45 | 9.44 | +++ | +++ | ++ | ++ | + |
| J16-O145 | 6.14 | +++ | +++ | ++ | + | |
| J17-O145 | 7.04 | +++ | +++ | ++ | + | |
| J18-O145 | 6.17 | +++ | +++ | ++ | + | |
| J19-O145 | 5.78 | | +++ | ++ | + | |
| J20-O145 | 6.72 | +++ | +++ | ++ | + | |
| J21-O145 | 6.74 | +++ | ++ | ++ | + | |
| J22-O145 | 6.65 | +++ | +++ | ++ | + | |
| J23-O145 | 6.80 | +++ | +++ | ++ | + | |
| J24-O145 | 6.34 | +++ | +++ | ++ | + | |
| J25-O145 | 6.51 | +++ | +++ | ++ | + | |
| J26-O145 | 6.34 | +++ | +++ | ++ | + | |
| J27-O145 | 6.41 | +++ | +++ | ++ | + | |
| J28-O145 | 6.79 | +++ | ++ | ++ | + | |
| J29-O145 | 6.83 | +++ | +++ | ++ | + | |
| J30-O145 | 6.08 | +++ | +++ | ++ | + | |

### Molecular Characterization

Phage-1 sequenced (clone 9356) fragment showed 97% similarity with other E. coli O157 phage with accession no. KP869105.1. The aligned sequence showed to be the RNA ligase coding sequence of P1. Phage-1 sequence also showed similarity (97%) with Enterobacteria phage ARI (accession no. AP011113.1) RNA ligase 2, whose function includes RNA replication, transcription and modification.

Phage-4 sequenced (clone 9237 and 9241) fragment showed 95% similarity with Salmonella phage accession number KM236244.1. Tail proteins of P4 are closely related with other enteric phages such as Salmonella, Vibrio, Yersinia, Pectobacterium, and T5-phage.

Phage-9 sequenced (clone 9315) region showed 78-80% similarity with Shigella phage pSb-1, Enterobacter phage-IME11 and Bp4, and different Escherichia phages such as EC1-UPM, vB_EcoP_PhAPEC5, ECBP1, vB_EcoP_PhAPEC7, vB_EcoP_G7C. The P9 (clone 9315) sequence showed homology with hypothetical protein encoded by similar sequence of above mentioned phages. Results from Escherichia phage vB_EcoP_PhAPEC5 alignment showed that small fragment of P-9 sequenced DNA (clone 9315) could be similar to putative portal proteins. This putative portal protein may play a role in head assembly, genome packaging, neck/tail attachment, and genome ejection.

Phage-9 sequenced (clone 9319) region showed 83-84% similarity with Shigella phage pSb-1, Enterobacter phage-IME11 and Bp4, and different Escherichia phages such as EC1-UPM, vB_EcoP_PhAPEC5, ECBP1, vB_EcoP_PhAPEC7, vB_EcoP_G7C. The P9 (clone 9319) sequence showed homology with RNA polymerase encoded by 83% similar sequences of above mentioned phages.

TABLE 15
In-vitro (microtiter plates) STEC Biofilm Inhibition Assays:
Individual Phage treatments

| | Absorbance | | | Reduction in Absorbance | |
|---|---|---|---|---|---|
| Treatments | 0 hr | 3 hr | 6 hr | 3 hr | 6 hr |
| Control O157 | 0.476 | 0.795 | 0.563 | −0.319 | −0.087 |
| P1 | 0.696 | 0.461 | 0.350 | 0.235 | 0.346 |
| P2 | 0.520 | 0.325 | 0.207 | 0.195 | 0.313 |
| P3 | 0.472 | 0.284 | 0.322 | 0.187 | 0.150 |
| P4 | 0.668 | 0.307 | 0.202 | 0.360 | 0.466 |
| P5 | 0.581 | 0.392 | 0.490 | 0.188 | 0.090 |
| P6 | 0.647 | 0.350 | 0.295 | 0.297 | 0.352 |
| P7 | 0.620 | 0.357 | 0.501 | 0.264 | 0.120 |
| Control O26 | 1.683 | 0.672 | 0.791 | 1.010 | 0.892 |
| P10 | 2.021 | 0.729 | 1.168 | 1.292 | 0.853 |
| P11 | 2.631 | 0.784 | 1.537 | 1.847 | 1.094 |
| P12 | 2.091 | 0.956 | 1.391 | 1.135 | 0.700 |
| P13 | 2.263 | 0.908 | 1.195 | 1.355 | 1.067 |
| Control O45 | 2.538 | 1.194 | 2.024 | 1.344 | 0.514 |
| J11 | 1.638 | 1.935 | 2.902 | −0.297 | −1.265 |
| J12 | 2.174 | 0.783 | 2.845 | 1.391 | −0.671 |
| J13 | 3.144 | 1.877 | 3.384 | 1.267 | −0.240 |
| J14 | 2.609 | 1.445 | 2.584 | 1.164 | 0.025 |
| J15 | 2.761 | 1.583 | 3.519 | 1.178 | −0.758 |
| P9 | 3.225 | 1.387 | 3.288 | 1.839 | −0.062 |
| Control O103 | 3.215 | 1.683 | 2.040 | 1.532 | 1.175 |
| P18 | 3.004 | 1.761 | 3.577 | 1.244 | −0.572 |
| P19 | 3.553 | 1.571 | 1.403 | 1.982 | 2.150 |
| P20 | 3.582 | 1.566 | 1.232 | 2.016 | 2.350 |
| P21 | 3.725 | 1.397 | 1.492 | 2.328 | 2.234 |
| P22 | 2.638 | 1.422 | 1.438 | 1.216 | 1.200 |
| Control O111 | 3.448 | 1.488 | 1.374 | 1.960 | 2.075 |
| P14 | 3.853 | 1.504 | 1.691 | 2.349 | 2.162 |
| P15 | 3.831 | 1.235 | 1.400 | 2.596 | 2.431 |
| P16 | 2.993 | 1.159 | 1.039 | 1.834 | 1.954 |
| P17 | 3.674 | 1.502 | 2.142 | 2.171 | 1.532 |
| Control O121 | 1.717 | 1.301 | 1.146 | 0.416 | 0.571 |
| J1 | 1.944 | 1.289 | 1.200 | 0.655 | 0.744 |
| J2 | 1.893 | 1.937 | 1.350 | −0.045 | 0.543 |
| J3 | 1.924 | 1.213 | 1.088 | 0.710 | 0.836 |
| J4 | 1.812 | 1.439 | 1.048 | 0.373 | 0.764 |
| J5 | 1.712 | 1.754 | 1.614 | −0.042 | 0.098 |
| J6 | 1.838 | 1.896 | 1.224 | −0.059 | 0.613 |
| J7 | 1.750 | 1.477 | 1.061 | 0.273 | 0.689 |
| J8 | 2.303 | 2.239 | 2.412 | 0.064 | −0.109 |
| J9 | 1.734 | 1.661 | 1.242 | 0.072 | 0.492 |
| J10 | 2.034 | 1.743 | 1.612 | 0.291 | 0.422 |
| P8 | 1.737 | 2.133 | 2.180 | −0.395 | −0.443 |
| Control O145 | 1.412 | 0.735 | 0.699 | 0.678 | 0.713 |
| J16 | 1.218 | 1.171 | 1.485 | 0.047 | −0.267 |
| J17 | 1.034 | 0.943 | 1.114 | 0.091 | −0.080 |
| J18 | 1.284 | 1.010 | 1.386 | 0.274 | −0.102 |
| J19 | 1.281 | 1.395 | 1.455 | −0.114 | −0.173 |
| J20 | 1.248 | 1.357 | 1.297 | −0.110 | −0.049 |
| J21 | 2.263 | 0.723 | 1.169 | 1.540 | 1.094 |
| J22 | 1.547 | 1.459 | 1.564 | 0.088 | −0.017 |
| J23 | 1.775 | 1.265 | 1.545 | 0.510 | 0.230 |
| J24 | 2.009 | 0.978 | 1.175 | 1.031 | 0.834 |
| J25 | 1.614 | 0.712 | 0.506 | 0.901 | 1.108 |
| J26 | 1.742 | 0.531 | 1.024 | 1.212 | 0.718 |
| J27 | 1.841 | 0.506 | 0.730 | 1.336 | 1.112 |
| J28 | 1.492 | 0.807 | 0.850 | 0.685 | 0.642 |
| J29 | 2.087 | 0.586 | 0.898 | 1.501 | 1.189 |
| J30 | 1.859 | 0.831 | 1.165 | 1.028 | 0.694 |

TABLE 16
In-vitro (microtiter plates) STEC Biofilm Inhibition Assays:
Bacteriophage Cocktail Treatments

| | Absorbance | | | Absorbance Reduction | |
|---|---|---|---|---|---|
| Treatment | 0 hr | 3 hr | 6 hr | 3 hr | 6 hr |
| O157-Control | 2.101 | 0.941 | 1.085 | 1.160 | 1.016 |
| CT1 + O157 | 1.990 | 0.910 | 0.591 | 1.080 | 1.399 |
| CT2 + O157 | 2.319 | 1.139 | 0.548 | 1.180 | 1.772 |
| CT3 + O157 | 2.250 | 0.748 | 0.531 | 1.502 | 1.719 |
| CT4 + O157 | 2.329 | 0.941 | 0.573 | 1.388 | 1.756 |
| O26-Control | 2.232 | 1.389 | 1.012 | 0.842 | 1.220 |
| CT5 + O26 | 2.649 | 1.453 | 0.843 | 1.196 | 1.806 |
| O45-Control | 2.152 | 1.048 | 1.252 | 1.104 | 0.899 |
| CT6 + O45 | 1 612 | 1.305 | 0.996 | 0.307 | 0.616 |
| O103-Control | 2.597 | 1.084 | 1.467 | 1.512 | 1.130 |
| CT7 + O103 | 2.484 | 1.502 | 0.596 | 0.982 | 1.888 |
| O111-Control | 2.338 | 0.394 | 0.878 | 1.943 | 1.460 |
| CT8 + O111 | 3.249 | 0.395 | 0.552 | 2.854 | 2.697 |
| O121-Control | 2.598 | 0.436 | 1.251 | 2.162 | 1.347 |
| CT9 + O121 | 3.074 | 0.594 | 1.123 | 2.480 | 1.951 |
| CT10 + O121 | 3.226 | 0.464 | 0.776 | 2.762 | 2.450 |
| O145-Control | 2.893 | 0.809 | 0.677 | 2.084 | 2.217 |
| CT11 + O145 | 2.695 | 0.339 | 0.677 | 2.356 | 2.018 |
| CT12 + O145 | 2.552 | 0.851 | 0.806 | 1.700 | 1.746 |

Table 17a-b. STEC Biofilm Inhibition on Stainless Steel (SS) and High Density Polyethylene (HDPE) Surfaces

TABLE 17a

| STEC | | |
|---|---|---|
| Strain | Bacterial Cocktail | Phage Cocktail |
| O157 | ATCC 43895, Wild Type: LF4, | CT3: P3, P5, P7 |
| | KF10 | |
| O26 | CDC 03-3014, Wild Type: BF8, | CT5: P10, P11, P12, P13 |
| | QF6 | |
| O45 | CDC 00-3039, Wild Type: AF1, | CT6: P9, J12, J13, J15 |
| | EF2 | |
| O103 | CDC 06-3008, Wild Type: GF6, | CT7: P19, P20, P21 |
| | AF10 | |
| O111 | CDC 2010C-3114, ATCC: 2440, | CT8: P14, P15, P16, P17 |
| | 2180 | |
| O121 | CDC 02-3211, ATCC: 2219, 2203 | CT10: P8, J3, J6, J9 |
| O145 | CDC 99-3311, ATCC: 2208, 1652 | CT11: J21, J24, J26, J27 |

TABLE 17b

| Stainless | Log | | | Log | Log |
|---|---|---|---|---|---|
| Steel | values | Log Reduction | HDPE | values | Reduction |
| CON-O157 | 2.6 | | CON- | 4.9 | |
| | | | O157 | | |
| Phage Trt- | 0.7 | 1.9 (almost | Phage | 0.8 | 4.1 |
| CT3 | | complete | Trt-CT3 | | (almost |
| | | reduction) | | | complete |
| | | | | | reduction) |
| CON-O26 | 3.6 | | CON-O26 | 4.5 | |
| Phage Trt- | 0.5 | 3.1 (almost | Phage | 2.2 | 2.3 |
| CT5 | | complete | Trt-CT5 | | |
| | | reduction) | | | |
| CON-O45 | 3.2 | | CON-O45 | 5.6 | |
| Phage Trt- | 0.0 | 3.2 (complete | Phage | 0.3 | 5.3 |
| CT6 | | reduction) | Trt-CT6 | | (complete |
| | | | | | reduction) |
| CON-O103 | 3.8 | | CON- | 5.0 | |
| | | | O103 | | |
| Phage Trt- | 2.0 | 1.8 | Phage | 3.9 | 1.2 |
| CT7 | | | Trt-CT7 | | |
| CON-O111 | 3.8 | | CON- | 5.7 | |
| | | | O111 | | |
| Phage Trt- | 0.0 | 3.8 (complete | Phage | 0.0 | 5.7 |
| CT8 | | reduction) | Trt-CT8 | | (complete |
| CON-O121 | 4.3 | | CON- | 5.9 | reduction) |
| | | | O121 | | |
| Phage Trt- | 0.0 | 4.3 (complete | Phage | 0.0 | 5.9 |
| CT10 | | reduction) | Trt-CT10 | | (complete |
| CON-O145 | 4.3 | | CON- | 5.9 | reduction) |
| | | | O145 | | |
| Phage Trt- | 0.0 | 4.3 (complete | Phage | 0.0 | 5.9 |
| CT11 | | reduction) | Trt-CT11 | | (complete |
| | | | | | reduction) |

CON = Bacterial Control;
CT = Cocktail Treatment

Table 18a-b. Inhibition of STEC on Leafy Greens Using Individual (all 6 Non-O157 STEC Strains) or Cocktail (for O157 Only) of Phages

CON=Bacterial Control; CT=Cocktail Treatment; PBS=Phosphate Buffered Saline (experimental control)

TABLE 18a
Baby Spinach

| | Log values | | | Log reductions | | |
|---|---|---|---|---|---|---|
| Treatments | Day 0 | Day 1 | Day 3 | Day 0 | Day 1 | Day 3 |
| O157-CON | 2.75 | 2.77 | 2.86 | | | |
| O157-PBS | 2.92 | 3.06 | 3.03 | −0.17 | −0.30 | −0.17 |
| O157-CT4 | 1.34 | 1.49 | 1.24 | 1.41 | 1.28 | 1.62 |
| O26- CON | 2.90 | 2.89 | 2.90 | | | |
| O26-PBS | 2.91 | 2.91 | 2.93 | −0.01 | −0.02 | −0.03 |
| O26-P13 | 0.00 | 0.57 | 0.58 | 2.90 | 2.32 | 2.32 |
| O45- CON | 2.88 | 2.94 | 2.92 | | | |
| O45-PBS | 2.90 | 2.93 | 2.92 | −0.02 | 0.01 | 0.00 |
| O45-P9 | 0.00 | 0.00 | 0.00 | 2.88 | 2.94 | 2.92 |
| O103-CON | 2.91 | 2.94 | 2.94 | | | |
| O103-PBS | 2.89 | 2.91 | 2.94 | 0.02 | 0.04 | 0.00 |
| O103-P19 | 0.10 | 0.00 | 0.20 | 2.81 | 2.94 | 2.74 |
| O111- CON | 2.92 | 2.93 | 2.92 | | | |
| O111-PBS | 2.93 | 2.94 | 2.95 | −0.01 | 0.00 | −0.03 |
| O111-P14 | 0.00 | 0.00 | 0.00 | 2.92 | 2.93 | 2.92 |
| O121-CON | 2.84 | 2.81 | 2.86 | | | |
| O121-PBS | 3.23 | 3.18 | 3.17 | −0.39 | −0.37 | −0.31 |
| O121-P8 | 1.56 | 1.50 | 1.23 | 1.28 | 1.31 | 1.63 |
| O145-CON | 2.92 | 2.84 | 2.89 | | | |
| O145-PBS | 2.89 | 2.85 | 2.91 | 0.03 | −0.01 | −0.02 |
| O145-P7 | 1.40 | 1.26 | 1.33 | 1.52 | 1.58 | 1.57 |

TABLE 18b
Romaine Lettuce

| | Log values | | | Log reductions | | |
|---|---|---|---|---|---|---|
| Treatments | Day 0 | Day 1 | Day 3 | Day 0 | Day 1 | Day 3 |
| O157-CON | 2.87 | 2.84 | 2.89 | | | |
| O157-PBS | 2.85 | 2.90 | 2.95 | 0.02 | −0.06 | −0.06 |
| O157-CT4 | 0.06 | 0.18 | 0.33 | 2.81 | 2.66 | 2.56 |
| O26- CON | 2.93 | 2.93 | 2.94 | | | |
| O26-PBS | 2.92 | 2.93 | 2.94 | 0.01 | −0.00 | 0.01 |
| O26-P13 | 0.00 | 0.26 | 0.16 | 2.93 | 2.67 | 2.78 |
| O45- CON | 2.87 | 2.94 | 2.99 | | | |
| O45-PBS | 2.87 | 2.96 | 2.98 | 0.00 | 0.02 | 0.01 |
| O45-P9 | 0.00 | 0.00 | 0.00 | 2.87 | 2.94 | 2.99 |
| O103-CON | 2.93 | 2.96 | 2.97 | | | |
| O103-PBS | 2.95 | 2.94 | 2.95 | −0.02 | 0.02 | 0.02 |
| O103-P19 | 0.00 | 0.00 | 0.10 | 2.93 | 2.96 | 2.87 |
| O111- CON | 2.95 | 2.98 | 2.96 | | | |
| O111-PBS | 2.95 | 2.96 | 2.95 | 0.00 | 0.02 | 0.01 |
| O111-P14 | 0.00 | 0.00 | 0.00 | 2.95 | 2.98 | 2.96 |
| O121-CON | 2.81 | 2.94 | 2.89 | | | |
| O121-PBS | 2.87 | 2.90 | 2.92 | −0.06 | 0.04 | −0.02 |
| O121-P8 | 1.24 | 1.05 | 1.06 | 1.57 | 1.89 | 1.84 |
| O145-CON | 2.92 | 2.62 | 2.96 | | | |
| O145-PBS | 2.93 | 2.61 | 2.95 | −0.01 | 0.01 | 0.00 |
| O145-P7 | 1.03 | 1.15 | 1.14 | 1.89 | 1.47 | 1.82 |

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of killing or inhibiting growth of shigatoxigenic Escherichia coli (STEC) comprising
contacting the STEC with a composition comprising at least one of the following bacteriophages:
P1 (C-1)
P2 (C-2)
P3 (C-3)
P4 (C-4)
P5 (C-5)
P6 (D-2)
P7 (G-5)
P8 (A-7)
P9 (A-7)
P10 (A-1)
P11 (A-5)
P12 (D-2)
P13 (D-5)
P14 (I-1)
P15 (I-2)
P16 (I-4)
P17 (I-5)
P18 (I-1)
P19 (I-2)
P20 (I-3)
P21 (I-4)
P22 (I-5)
J-1 (D-1)
J-2 (D-2)
J-3 (D-3)
J-4 (B-1)
J-5 (B-3)
J-6 (B-4)
J-7 (B-5)
J-8 (I-2)
J-9 (I-3)
J-10 (I-4)
J-11 (D-1)
J-12 (D-2)
J-13 (D-3)
J-14 (D-4)
J-15 (D-5)
J-16 (B-1)
J-17 (B-2)
J-18 (B-3)
J-19 (B-4)
J-20 (B-5)
J-21 (D-1)
J-22 (D-2)
J-23 (D-3)
J-24 (D-4)
J-25 (D-5)
J-26 (I-1)
J-27 (I-2)
J-28 (I-3)
J-29 (I-4)
J-30 (I-5)

2. The method of claim 1, wherein said composition comprises a plurality of bacteriophages.

3. The method of claim 1, wherein said STEC is a serotype selected from the group consisting of O157:H7, O26, O111, O103, O121, O145, and O45.

4. The method of claim 1, wherein said contacting step comprises applying, spraying or drenching a surface with the composition.

5. The method of claim 4, wherein the surface is or is present in or on:
food processing equipment, flooring, food-contact surfaces, or non-food-contact surfaces.

6. The method of claim 4, wherein the surface is or is present in or on a carcass or fresh produce.

7. A method of preventing or reducing formation of a STEC biofilm on a surface, comprising,
applying to the surface a composition comprising at least one of the following bacteriophages:
P1 (C-1)
P2 (C-2)
P3 (C-3)
P4 (C-4)
P5 (C-5)
P6 (D-2)
P7 (G-5)
P8 (A-7)
P9 (A-7)
P10 (A-1)
P11 (A-5)
P12 (D-2)
P13 (D-5)
P14 (I-1)
P15 (I-2)
P16 (I-4)
P17 (I-5)
P18 (I-1)
P19 (I-2)
P20 (I-3)
P21 (I-4)
P22 (I-5)
J-1 (D-1)
J-2 (D-2)
J-3 (D-3)
J-4 (B-1)
J-5 (B-3)
J-6 (B-4)
J-7 (B-5)
J-8 (I-2)
J-9 (I-3)
J-10 (I-4)
J-11 (D-1)
J-12 (D-2)
J-13 (D-3)
J-14 (D-4)
J-15 (D-5)
J-16 (B-1)
J-17 (B-2)
J-18 (B-3)
J-19 (B-4)
J-20 (B-5)
J-21 (D-1)
J-22 (D-2)
J-23 (D-3)
J-24 (D-4)
J-25 (D-5)
J-26 (I-1)
J-27 (I-2)
J-28 (I-3)
J-29 (I-4)
J-30 (I-5)

8. The method of claim 7, wherein said composition comprises a plurality of bacteriophages.

9. The method of claim 7, wherein said STEC is a serotype selected from the group consisting of O157:H7, O26, O111, O103, O121, O145, and O45.

10. The method of claim 7, wherein said contacting step comprises applying, spraying or drenching a surface with the composition.

11. The method of claim 7, wherein the surface is or is present in or on:
food processing equipment, flooring, food-contact surfaces, or non-food-contact surfaces.

12. The method of claim 7, wherein the surface is or is present in or on a carcass or fresh produce.
